(19) United States
(12) Patent Application Publication
(10) Pub. No.: US 2002/0065946 A1
(43) Pub. Date: May 30, 2002

(54) Synchronized computing with internet widgets

(76) Inventor: Shankar Narayan, Sunnyvale, CA (US)

Correspondence Address: HICKMAN PALERMO TRUONG & BECKER, LLP, 1600 WILLOW STREET, SAN JOSE, CA, 95125, US

(21) Appl. No.: 09/981,189

(22) Filed: Oct. 16, 2001

Related U.S. Application Data
(60) Provisional application No. 60/241,447, filed on Oct. 17, 2000.
(60) Provisional application No. 60/241,273, filed on Oct. 17, 2000.

(51) Int. Cl. G06F 9/44; G06F 9/46

(52) U.S. Cl. 709/315; 709/330

(57) ABSTRACT

Synchronized computing routes data and code to desired destinations of computers from various locations where the data and code is stored. Synchronized computing securely synchronizes the movement of data and code to perform desired computation. To support synchronized computing, a client generates proxy objects that, when executed, serve as gateways between local objects of the client and remote objects that may reside on servers connected to the client over a network. The client generates the proxy objects based on an (1) interface definition that may be downloaded over a network and (2) policy access data that may reside on the client. The proxy objects are generated so that they control access according to access rules defined by the policy access data.

### RELATED APPLICATIONS

This application claims priority to U.S. Provisional Patent Application No. 60/241,447, entitled “Internet Widgets and an Architecture to Create Integrated Service Ecosystems Using Internet Widgets”, filed by Shankar Narayan on Oct. 17, 2000, the contents of which are incorporated by reference in its entirety.

This application claims priority to U.S. Provisional Patent Application No. 60/241,273, entitled “Question Associated Information Storage and Retrieval Architecture Using Internet Gidgets”, filed by Shankar Narayan on Oct. 17, 2000, the contents of which are incorporated by reference in its entirety.

This application is related to the United States Patent Application entitled “Pluggable Instantiable Distributed Objects”, attorney docket number 60033-0012, filed on the equal day herewith by Shankar Narayan, the contents of which are herein incorporated by reference in its entirety.

This application is related to the United States Patent Application entitled “Question Associated Information Storage and Retrieval Architecture Using Internet Gidgets”, attorney docket number 60033-0017, filed on the equal day herewith by Shankar Narayan, the contents of which are herein incorporated by reference in its entirety.

### FIELD OF THE INVENTION

The present invention relates to distributed computing in a network environment.

### SUMMARY OF THE INVENTION

Described herein are various mechanisms that may be used to support synchronized computing. In general, synchronized computing routes data and code to desired destinations of computers from various locations where the data and code is stored. Synchronized computing securely synchronizes the movement of data and code to perform desired computation. According to an aspect of the present the invention, a client generates proxy objects based on an (1) interface definition that may be downloaded over a network and (2) policy access data that may reside on the client. The proxy objects, when executed, serve as gateways between local objects of the client and remote objects that may reside on servers connected to the client over a network. The proxy objects are generated so that they control access according to access rules defined by the policy access data.

### ORGANIZATIONAL OVERVIEW

1.0 Introduction:

In this document a new type of computing called synchronized computing is introduced and the benefits of using this model of computing are also described. At a very high level, synchronized computing routes the data and code to desired destinations of computers from various locations where the data and code is stored. In other words synchronized computing synchronizes the movement of data and code to perform desired computation. The architectural model of computing that is at the heart of the synchronized computing is presented. Also described are the various software elements that need to be implemented to facilitate synchronized computing. The rest of the document is structured into the following sections:

Historical precursors to synchronized computing

The description of synchronized computing

Security in synchronized computing

Proxification of interfaces, a security technique

Test methodology of testing internet widgets in synchronized computing

Various roles of people using synchronized computing

Scenarios of usage of synchronized computing

Enumeration of various advantages by using synchronized computation model

Conclusions

To aid in the implementation of synchronized computing infrastructure, we identify the implementables through out the document with the same subtitle.

### BACKGROUND

2.0 Historical Precursors to Synchronized Computing:

Historically computing started from where the data and the software that operated on the data existed on a single computer. This model required that the programs (or the code) and the data were to be loaded into the computer for performing some useful computation. The next evolutionary step in computing was distributed computing. With distributed computing, several computers were connected as a network of computers. The programs (the code) were still installed on computers and were executed on the computers on which it was installed. The data once loaded initially on storage systems that were connected to one of the computers in the network was mobile. In essence data could be moved from any part of the network to any other part of the network if such movement helped in performing computation. Distributed computing has been in vogue for quite some time now. The more recent development that happened with the advent of JAVA in the evolution of computing is mobile/portable computing revolution where the code and the programs became portable across multiple platforms and hence were considered more mobile than applications that could be executed only on certain platforms. JAVA is the immediate precursor to synchronized computing that is described in this document. Considering code and programs are a particular type of data, one could be of the opinion that code as with data was mobile with the advent of distributed computing. The difference that has made the usefulness of the JAVA like mobile code [TIMF97], in the form of data, more useful is the ability to use the same program/code in multiplicity of computers due to its portability much more than anytime before. As the code became mobile, it was possible for anyone with a computer to obtain the programs/code created in this manner and to execute it on any platform of their choice. This became particularly useful in the context of the internet where the content providers could create applications that would be accessed by users with disparate types of computers.

The routing infrastructure that provides multiplicity of ways in which-data can be routed to facilitate computing has made possible for some very useful applications such as e-mail, http based web, ftp, rpcs, distributed objects [OMG97] etc. In effect the additional layers of abstraction built on top of the simple notion that data attached to computers, that are addressable, is in itself addressable, and that this data can be routed between various addressable computer sources and destinations has made possible for applications with desirable attributes of computing. Compared to the infrastructure that exists to facilitate these types of computing based on mobile data the infrastructure that exists to create interesting applications based on the ability to move code from one addressable computing source to another addressable computing destination is quite primitive. It is here that synchronized computing will define a routing abstraction on top of the existing solutions to conjure some applications that have not been created thus far in known literature.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a block diagram depicting an architectural view of various computing resources that participate in synchronized computing according to an embodiment of the present invention;

FIG. 2 is a block diagram depicting an architectural view of various computing resources that participate in synchronized computing according to an embodiment of the present invention;

FIG. 3 is a block diagram depicting a containment hierarchy of serialized persistent objects of internet widgets according to an embodiment of the present invention;

FIG. 4 is a block diagram depicting a computing utility according to an embodiment of the present invention;

FIG. 5 is a block diagram depicting participants and actions performed by them in a process to bind local persistent objects of serialized internet widgets according to an embodiment of the present invention;

FIG. 6 is a block diagram depicting the partitioning of a computing utility according to an embodiment of the present invention;

FIG. 7 is a block diagram representing a global name service composed of several regional name services in a given computing utility according to an embodiment of the present invention;

FIG. 8 is a block diagram showing various elements of managing a computing utility as the load is fluctuating according to an embodiment of the present invention;

FIG. 9 is a block diagram depicting an IVDO and an IPDO that can engage in un-proxified communication;

FIG. 10 is a block diagram depicting elements that enable an IVDO and an IPDO to engage in proxified communication according to an embodiment of the present invention;

FIG. 11 is a block diagram depicting a ClientIVDOGateway and a ClientIPDOGateway generated from forward a IDL file and a backward IDL file according to an embodiment of the present invention according to an embodiment of the present invention;

FIG. 12 is a block diagram depicting an IVDO and IPDO configured for un-proxified communication between them;

FIG. 13 is a block diagram depicting an IVDO and an IPDO that route method invocations through a ClientIVDOGateway object according to an embodiment of the present invention;

FIG. 14 is a block diagram depicting a trust model based on distributed computing;

FIG. 15 is a block diagram depicting a trust model based on synchronized computing according to an embodiment of the present invention;

FIG. 16 is a block diagram depicting fragmentation of user data that may occur under the distributed model;

FIG. 17 is a block diagram depicting a consolidation of user data based on synchronized computing according to an embodiment of the present invention; and

FIG. 18 is a block diagram depicting a computer system that may be used to implement an embodiment of the present invention.

### DETAILED DESCRIPTION

A method and apparatus for synchronized computing is described. In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

3.0 The Description of Synchronized Computing:

Let us first describe the form of computing in a descriptive manner without any formalism to give an intuitive understanding of what synchronized computing is.

3.1 Overview

Intuitively, synchronized computing is a form of computing where addressable data (where the location of the data resides) and addressable code (where the location of the code resides) is synchronized to be executed on desired computers that are themselves addressable. Since the code/program can dynamically invoke other code modules that are not explicitly invoked by the invoker of an application these (code/data) in turn have to be synchronized to be executed on desired computers. That is, in a network of computers, synchronized computing will synchronize the movement of data and code in such a manner that they are executed in computers that have desired characteristics. The desired characteristics of computers on which the synchronized code is executed are factors such as platform appropriateness (printing software on a computer connected to a printer, smart card software on a smart card, or any device related software on those devices), or those computers that are within the boundaries of trust that a user is willing to trust (such as machines within a corporate firewall, or the machines within the home network etc.) Considering the infrastructure that has to be constructed to facilitate synchronized computing does so to meet the objectives of synchronized computing it is imperative that we outline objectives of synchronized computing at the outset. We will also presume that the infrastructure that is needed for supporting synchronized computing is constructed using the idioms developed in Internet Widgets. [SHAN00].

At a very high level, the objectives of synchronized computing are captured here, and these will be the advantages that will be delivered to various players in computing. These objectives will be re-visited in the advantages section where we describe in detail how synchronized computing delivers these advantages to the different players. The expected advantages that will be delivered to various players in computing are:

3.1.1 Expected Advantages to the Software Purchaser:

1. A pay per use model is an option internet widget vendors can make available to the software buyer.

2. A subscription model is another option internet widget vendors will be able to make possible for software purchaser.

3.1.2 Expected Advantages to the Software Deployer:

3. Hardware capacity planning is obviated

4. Clearly defined boundary of trust that permits mobility of shareable data and hence communication with peers outside the boundary of trust in a secure manner.

5. On demand increase of computational power.

3.1.3 Expected Advantages to the Software Developer:

6. Increased software reuse

7. Dynamic binding with available services within a computing utility

8. Specialist creating the internet widget that comprises of all the layers from the UI to the hardware

9. Makes it possible for developers to use virtual objects to program networked devices.

3.1.4 Expected Advantages to the Hardware Developer:

10. A framework for creating networked devices that can be integrated into software applications with superior quality of integration

11. Networked device operational framework.

3.1.5 Expected Advantages to the Software User:

12. Consolidation of trust (i.e no fragmentation of trust)

13. Consolidation of user data

14. Improved security for executing applications from dubious sources

15. Infinitely scalable computing utility

16. Superior integration of hardware that is part of the user's home compute set

17. Secure single sign on with multiple internet services that have different usernames and passwords

18. Ubiquitous access to computing, application and data resources

19. Easy migration between computing utility providers

### Computing Utility

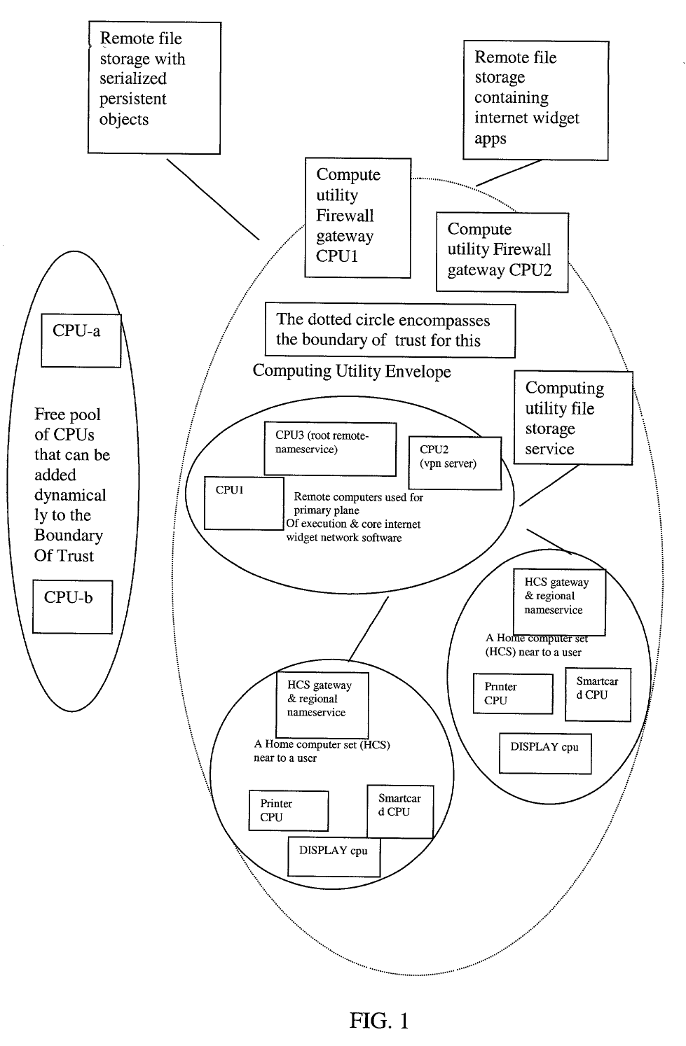

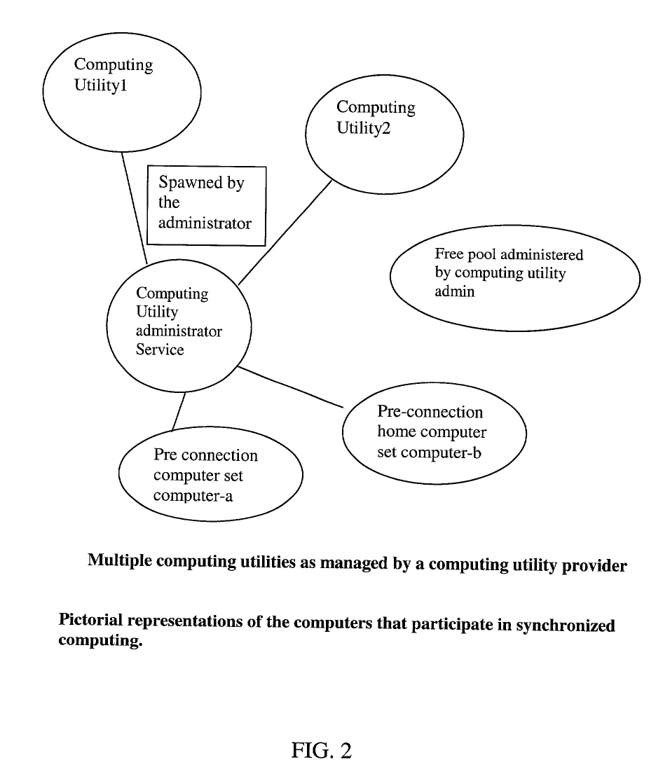

FIGS. 1 and 2 depict the architectural view of various computing resources that participate in synchronized computing. The above architectural view is modeled to encapsulate how computing resources are viewed by organizations and individuals from their vantage point. Typically a set of computing resources are considered trusted by organizations and individuals based on their organizational affiliations and the hardware/software combination used to guard these resources. A home user may consider her computer a trusted computer and every other device that the user interacts with over the internet as less trustworthy compared to her own. Similarly, an organization may use firewalls [YOU] to define the network boundary within which the devices and resources are considered trust worthy and anything outside is less trustworthy. The above pictorial representation is explained in great detail in the remainder of this document.

We will begin our description of synchronized computing by defining certain terms that are extensively used in this document.

3.2 Definitions of Architectural Elements:

Boundary of Trust:

The boundary of trust is the virtual boundary that includes various networked computing devices that are able communicate with each other without ever traversing a gateway/firewall of any type. Access to any computer device outside the boundary of trust always vectors through a gateway that protects the network access to any computer inside the boundary of trust.

Computing Utility Envelope:

Computing utility envelope is the envelope of all the computing devices and resources that are within the boundary of trust. The number of computing devices within the boundary of trust can be expanded as and when needed.

Home Computing Utility Devices Set:

The devices that belong to the computing utility envelope can be partitioned into home computers and remote computers by their proximity to the user. Certain devices such as display devices, smart cards, and perhaps printers have to be close to the user of the computing utility for maximum benefit. All these devices belonging to the home computing set are connected by a network. The rest of the devices whose services are such that they can be much further apart need not be close to the user. One of the benefits of synchronized computing is to make it possible for users to tap into a remotely managed computing utility that expands and collapses on the fly as the need may be.

Remote Computing Utility Devices Set:

The remote computing utility devices also are within the boundary of trust in a computing utility, but they are devices that may be in a location away from the user. In a typical configuration of synchronized computing, only those devices that a user needs to have locally available reside near the user, and all other devices that may be used during the execution of an application reside in a remote location. These remote devices are acquired, administered and managed by a computing utility administrator (plausibly, a current day internet service provider can perform this role).

External Devices:

The external devices are those devices that are outside the boundary of trust for a given computing utility envelope.

Computing Utility Provider:

Computing utility provider is the vendor that facilitates the users to acquire an expandable computing utility. Different users with their local computers contact the computing utility provider through the computing utility administration service which is a constantly running in a shared computing utility run by the computing utility provider.

Computing Utility Administrator Service:

The computing utility administrator service is the service local computers (in particular the display computers) connect to. The computing utility administrator service lets the user to spawn a computing utility that belongs solely to the user, and from that point forward the local computer is connected only to the computing utility spawned.

Spawning of a Computing Utility:

When a computing utility is spawned for a user, it will start a global nameservice on a computer and the gate keeping software on the computer(s) designated for interacting with computers outside the boundary of trust. It also enlists the display computer as a device capable of executing display related internet widgets.

Minimum Software on Devices that Function or Desire to Function in a Computing Utility Envelope:

All the computers that function within a computing utility envelope need to run some unspecified minimum software. This software includes things such as the internet widget infrastructure software, and network protocol stack.

Trusted Computing Base (TCB):

Trusted computing base contains the software/code/programs and data that is always obtained from sources within the boundary of trust. During the course of the document we will identify the code and applications that belong to the trusted computing base. In the topology described above, the TCB is defined for computing resources within a give boundary of trust.

Gateways at the Periphery of the Boundary of Trust:

Not all devices in a network with well defined boundaries of trust are permitted to connect to resources outside the boundary of trust. In order to access devices outside the periphery of the boundary of trust, the user/application needs to route its communication through the gateways. The networked namespace maintains the permitted gateways within a given boundary of trust.

Computing Utility Envelope Authentication Virtual Service Internet Widget:

Before any device/user/application can connect to a computing utility envelope an authentication sequence needs to take place to allow new devices into the boundary of trust. This authentication sequence needs to be facilitated by the computing utility for all comers and hence the gateways to the boundaries of trust will allow the launch of the authentication application using the authentication virtual service internet widget. It is specified that a given device at any given time be within a single boundary of trust. In future agents may be able to spot newly added devices simultaneously belonging to multiple computing utility envelopes. A user may join the envelope using a display device, and they may use a smart card to store the authentication information to join a computing utility. This may require limited nameservice availability outside the boundary of trust on the gateway to execute the authentication internet widget and the internet widgets such as smart card device services. Devices should be able to authenticate without a user needing to interact during the authentication sequence.

Note: Besides the computing utility envelope authentication VSIW, individual applications may use an authentication virtual service internet widget that is the same or different from the authentication virtual service internet widget used for authenticating with the computing utility.

Access Control Virtual Service Internet Widget:

An access control virtual service internet widget is the central policy defining access control VSIW that is used to administer, and utilize for access control policy of local file storage. Role-based access control is central to ensuring authorized access to digital data [DAVJ95]. The access control VSIW belongs to the trusted computing base within the boundary of trust. One of the main users of the access control subsystem in enforcing and administering policy is the file/data service internet widget. The primitive entities that are used in defining policy are users & code (applications/internet widgets etc.). In other words the signed application and the user that is using the application together determine whether a certain resource is allowed for access or not. More sophisticated access control policy may build role & rule based access control systems. The user through the TCB code can authorize access to the data maintained in the file storage to various applications. Unless the user authorizes access to data, applications cannot access any data, be it persistently stored objects or the implementations of internet widgets.

Global & Application Namespace Within a BOT:

The internet widgets use a global and application namespace that is accessible to various elements of applications within a boundary of trust. (These elements too belong to the trusted computing base). The global namespace service is initiated at the startup of a boundary of trust in a manner that makes it feasible for any process/device started to find the global namespace before finding anything else.

External Namespace Visible Outside a BOT:

A computing utility envelope can allow applications/users from outside the boundary of trust access service internet widgets whose IPDOs are executed on devices inside a boundary of trust. They can allow access to the implementations of internet widgets that can be retrieved to be executed outside the boundary of trust in another computing envelope. In order to be able to permit this a computing utility envelope will need to execute certain IPDO proxies and namespaces outside the boundary of trust and vector through the gateway computer to access the content and functionality from within a boundary of trust.

Data Storage Virtual Service Internet Widget:

Each boundary of trust has one are more data storage locations made available through the global namespace to store applications and persistently stored objects. (Every boundary of trust will have at least one such internet widget that belongs to the trusted computing base.)

Instantiating Internet Widgets:

To instantiate internet widgets on computing devices within the computing utility envelope, an internet widget instantiating sub-system is used. The internet widget instantiating subsystem is also part of the trusted computing base (TCB).

Synchronization Set:

Synchronization set is the set of attributes associated with an internet widget that is stored in persistent objects that contain the internet widgets as well as accompanying elements that are stored with a different filename extension along with the internet widget. In other words if internet widget IW1 contains an internet widget IW2 in the containment hierarchy, then IW1 maintains the synchronization set in memory and its persistent serialized storage and also creates a file element in the file storage with a file name extension that indicates the fact that it is the synchronization set of the internet widget serialized persistent object with the same name but different file extension (the file extensions need to be specified). It is the synchronization set of contained internet widget (IW1) in conjunction with the application/internet widget (IW2) invoking the internet widget IW1 that determine how the IW1 is instantiated. In other words the code in IW2 can override the synchronization set values corresponding to IW1.

Internet widget service providers (will some day replace all application service providers):

Internet widget providers maintain a root persistent object of serialized internet widget and the implementation of the internet widget code for first time users of the internet widget as an application to point their application launcher to execute the internet widget within their computing utility. These internet widget service providers are discovered by the user as a source of some application that they are interested in and point their application launcher to the internet service provider.

3.3 Some Important Objectives/Requirements of Code Executed in Synchronized Computing are:

1. That the code (an executable/application) is executed on computers that reside within a boundary of trust.

2. The code can be brought from computers outside the boundary of trust but is executed on computers within the boundary of trust.

3. Some applications and code are considered part of the “trusted computing base” of synchronized computing.

4. That the data used by the executing code is either brought from outside the boundary of trust or is obtained by the code from within the boundary of trust.

5. The infrastructure facilitates the executing code to access and transfer data to and from outside the boundary of trust using a controlled channel created by the trusted computing base code that is not obtained from outside.

6. That the cpu capacity inside the boundary of trust is dynamically increasable by dynamically adding computers with desired characteristics.

3.4 Brief Description of Internet Widgets:

Now let us describe synchronized computing using internet widgets and the execution of software applications in synchronized computing.

An application built using internet widgets specifications is composed of various internet widgets and the application itself is an internet widget in itself.

The instantiation of an internet widget uses a serialized persistent storage location of the internet widget to initialize the state of the internet widget.

A containment hierarchy defines the containment of the various internet widgets used in an application, and this containment hierarchy is an acyclic graph that is a tree. The serialized internet widgets used in the application in the local and remote storages retain the containment hierarchy when used with linked serialization.

3.5 Description and Use of Synchronization Set Data Format:

To facilitate synchronized computing, the internet widgets that contain other internet widgets keep certain synchronization data as part of the containing object. In describing internet widgets, we discussed linked serialization that requires containing objects to store the location on the persistent storage that contains the serialized representation of the contained object. The data stored in the synchronization set serves two purposes. The first is to facilitate the usage of the Distributed Object Instantiation subsystem by a containing object. The second is to make it possible for application launchers to use the data stored in the synchronization set to be read from a storage to launch the application whose root internet widget synchronization set is the top level internet widget of the application being launched.

Besides the location of the contained object's location of the persistent object (LPO) storage, the following attributes are also maintained in memory and in persistent storage of the containing object.

1. The type of computer on which this object/internet widget can be executed—TYPE_OF_COMPUTER

The type of computer can take some standardized values that describe special attributes of a given computer. e.g smart-card, printer, generic-computer (the assumption is that these computers can be given an instantiable distributed object (IDO) as described in the internet widget infrastructure document and they can execute the IDO—in other words we assume that all these computers have the internet-widget infrastructure already installed.)

2. The name of the internet widget class—IW_CLASS_NAME

3. The set of interfaces implemented by the internet widget class—IW_LIST_OF_INTERFACES

4. The location where the package that contains an implementation of the internet widget is kept within the boundary of trust IW_IMPLEMENTATION_PATH_NAME

5. The location where the package that contains an implementation of the internet widget is kept by the implementer of the application that may reside outside the boundary of trust IW_IMPLEMENTATION_DEFAULT_PATH_NAME

In effect every contained internet widget has the set (LPO, TYPE_OF_COMPUTER, IW_CLASS_NAME, IW_LIST_OF_INTERFACES, IW_IMPLEMENTATION_PATH_NAME, IW_IMPLEMENTATION_DEFAULT_PATH_NAME) called the “synchronization set” maintained by the containing object. When the containing object stores the serialized object of itself on a persistent store it stores all the elements of the synchronization set.

Considering the top most containing object is not contained by any other object, the application launcher that launches an application requires the “synchronization set” information to trigger the invocation of various internet widgets using the launch data maintained by the containing internet widgets.

Technically each internet widget can be launched as a separate application. Hence the synchronization set information maintained by the containing object is also stored, as part of the serialization of an application, at the file storage location where the linked serialized persistent object is stored on the disk.

Let us for simplicity suppose that an HTML tag is used to encode the information required to launch the highest level internet widget in the containment hierarchy. Also, let us assume that a web-browser can point to a web-page and obtain this HTML tag and use a browser plug-in to pass this information to an internet widget application launcher.

However it should be noted that the applications may be launched outside a web-browser and the application launcher requires the necessary information to launch the application.

The application launcher, like the IDO instantiation subsystem of the internet widget infrastructure also has access to the scheduler that can launch applications on cpus within the boundary of trust of the invoker of the application.

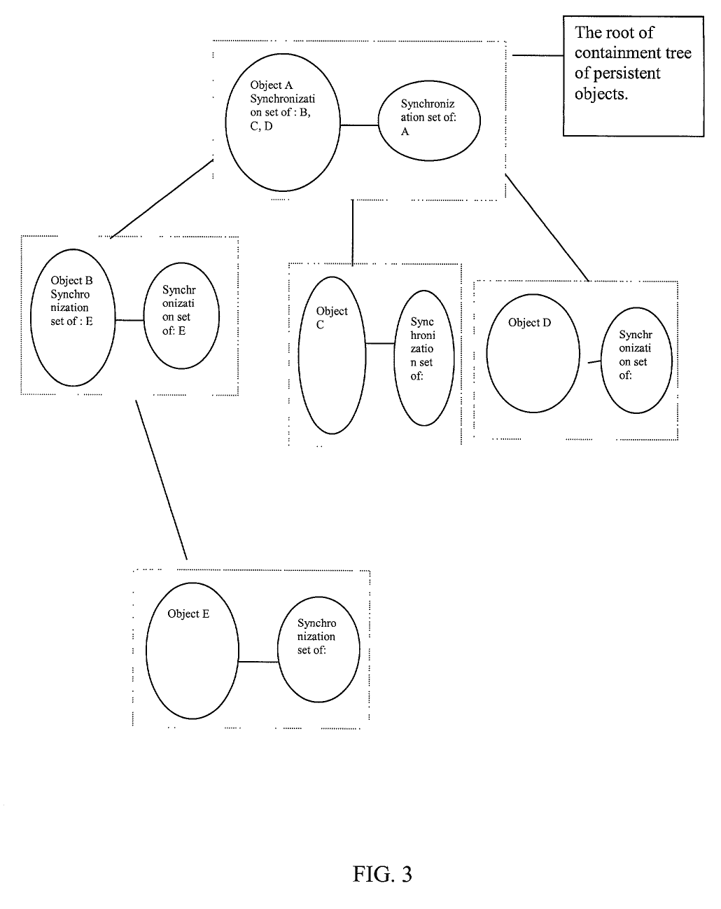

Pictorially, the containment hierarchy of serialized persistent objects of internet widgets involved in an application and the associated synchronization sets as it will span one or more file/data storages is shown in the FIG. 3.

3.5.1 Containment Hierarchy Several Serialized Internet Widgets Stored in Various File/Data Storages:

The persistent stored object used in the instantiation of an internet widget corresponding to an internet widget can reside either on a computer outside the boundary of the trust or on a computer that is inside the boundary of trust. Similarly the implementation of the internet widget that is executed as part of the application can be stored either outside or within the boundary of trust.

We will first describe how the internet widget code and their persistent objects are synchronized with the assumption that the IPDOs residing outside the boundary of trust can be used by IVDOs within the boundary of trust (BOT). This simplifying assumption is later done away with when we describe how interface proxification will build improved protection in communication between various computing utility envelopes.

Implementable:

Synchronization Set Editor.

Interfaces and implementation that will allow the instantiable distributed object to update and modify the synchronization set.

Interfaces and implementation that will allow the instantiable distributed object to read the synchronization set of child IDO that it instantiates.

3.6 Synchronization of an Application:

In this subsection we describe the process of synchronizing an application. The process of synchronizing an application can be sub-divided into the following sub processes namely:

1) application launching,

2) synchronization of constituent internet widgets,

3) first time invocation of a synchronized application where the application executes within a particular computing utility for the very first time,

4) Synchronized application binding with local data and services.

In this subsection we will describe in detail each of these sub-processes.

3.6.1 Application Launching:

As with any type of computing, the launching of the application is an essential element of synchronized computing. By design, the objective of way applications are launched in synchronized computing is to make it as similar to traditional application launching as possible, where the user may launch an application from a command line or a graphical user interface. This sub section describes the set of steps involved in the launching of an application.

The following steps describe the sequence of steps that happen when an application is launched by the application launcher:

1.0 The application launcher reads the synchronization set of the root internet widget A in the containment hierarchy.

2.0 It uses the instantiate sub-system for internet widgets to launch the top most internet widget A.

3.0 The top most internet widget may contain within it several other internet widgets such as B, C and D.

4.0 The internet widget is instantiated using a persistent object of the internet widget that would have synchronization sets of B, C and D.

5.0 Depending on the location of the persistent objects for the serialized internet widgets B, C and D, and the internet widget implementation of these widgets internet widget A supplies the synchronization set information to the internet widget instantiation subsystem.

6.0 Instantiation subsystem (TCB) will use the file/data retrieval internet widgets to retrieve the internet widget implementation and their persistent objects for initialization.

6.1 The internet widget framework will instantiate a limited set of special set of internet widgets as part of its execution. (they all belong to the TCB and are part of the core internet widget device software set and they in turn do not invoke other internet widgets.)

6.2 One such internet widget is a virtual service internet widget that can locate file storages given an address (such as ftp address) and retrieve the file.

6.3 This internet widget's IPDO and IVDO are separated by the boundaries of trust if the IPDO of the retrieved file resides outside the boundary of trust. This requires that the IVDO belong to TCB (and the core internet widget device software set) and not the IPDO. Considering IVDO cannot be downloaded from outside, it is necessary that the interfaces between the file service IVDOs and IPDOs are standardized between all computing utilities no matter where they are executed. The standard will be specifed. (The IVDOs can use the address information to contact the IPDOs and invoke the file retrieval methods.)

6.4 The other two special internet widgets that may be invoked by the instantiation sub-system are a primitive authentication internet widget and a limited local secure storage for preserving authorization credentials that may be supplied by a file transfer IPDO that may be used in subsequent accesses by the IPDO to the IVDO.

7.0 The instantiation subsystem will download the implementation and the persistent data object and instantiates them on a devices capable of executing the internet widget. If a persistent object does not exist at the location pointed to in the synchronization set and hence at the location pointed to by the argument to the instantiation sub system, then the instantiation sub-system will create a default object for that particular internet widget and use this location as the place to save the persistent object of the serialized internet widget.

8.0 Depending on the access control policy the changes made to the instantiated objects may or may not be committable to the file storage.

Implementables:

1. Application launcher that is executed on display computers and runs on majority of desktop and palmtop computers.

2. An application launcher as a plug-in for popular web-browsers.

3. HTML tag specification for top level internet widget's synchronization so that web browsers can launch synchronized apps.

4. Iconic rendering of most recently used and most frequently used synchronization sets on the user display computer as a way for user to manage the visual space of the desktop. (Some of the synchronization sets, the user may insist on being pinned to the desktop so that the above algorithms do not relegate these applications from the user desktop.)

5. TCB file/data access internet widget that can retrieve the internet widgets and their corresponding serialized objects from persistent storage from any where on the internet.

6. TCB authentication virtual service internet widget

7. TCB local secure storage virtual service internet widget

8. TCB access control virtual service internet widget

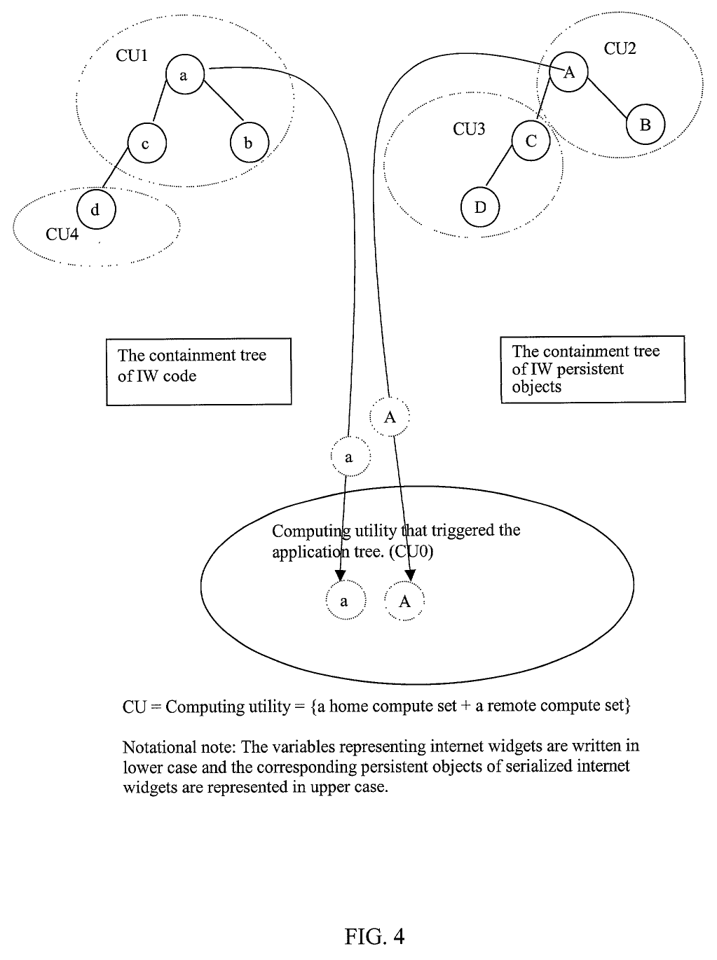

As one can see in FIG. 4 the various internet widget code and data is synchronized to be executed on the desired computing utilities. The display computing device will belong to the computing utility CU0, and the secondary object of the internet widget that executes on the secondary plane of execution is executed on the display device within the computing utility.

3.6.2 Synchronization of an Internet Widget:

Synchronization of an internet widget is the act of downloading the internet widget implementation and its corresponding persistent object into the boundary of trust of a computing utility and instantiating the internet widget with the downloaded implementation and its persistent object. While application launching is itself an act of synchronizing an internet widget, it is a special case situation of synchronization of an internet widget where the object that triggers the synchronization is the application launcher. This need not be the case for the generic act of synchronizing an internet widget as internet widgets can themselves trigger other internet widgets to be synchronized to be executed within the computing utility. In this subsection we will describe the generic synchronization of an internet widget.

The root persistent object of a serialized internet widget may reside on data storages that are both inside and outside of the boundaries of trust. Depending on the access control policy of the root persistent object of the serialized internet widget it may or may not be a shared data object or an object owned by single principal.

3.6.3 First Time Invocation of an Application Built for Synchronized Computing:

When a user uses an application for the very first time they point their application launcher to an internet widget service provider and this will let the user use a pre-saved root persistent serialized object of the internet widget that resides on a data storage maintained by the internet widget service provider. The access to this may or may not be granted to all users on the internet. In order for the user to customize the usage of the internet widget or the application that is obtained from the internet widget service provider the user should create a copy of the root persistent object of serialized internet widget on local storage so that the user can point the application launcher to the newly created root persistent object of serialized internet widget. This is necessary for users that do not want to be impacted by the changes that may be committed by others to the root persistent object of the serialized internet widget.

It is not adequate to commit the root persistent object to the local storage for all of the application elements to be completely controlled by the user. The user will need to commit all the internal internet widgets in the persistent object tree hierarchy as long as it is meaningful to commit these persistent objects locally. The application and internet widget instantiation infrastructure will make it possible for the user to save all of the containment tree locally.

If the user is using the application to browse a publicly visible application the user may not want to commit the persistent object hierarchy locally. Even in such situations, applications will sometimes want to create a custom containment tree hierarchy for the user to take advantage of local services such as printing and authentication etc. In the two scenarios, one in which the application attempts to use a previously created persistent data object that has already been created or the one in which the application attempts to bind to a local service such as printing to the application, the application attempts establish local bindings in the very first invocation. The initial invocation of the internet widget app using synchronized computing on the computing utility is called the first run. The following sub sections will describe in greater detail the steps that an application goes through to create these bindings on the first run.

Implementable:

The core internet widget network software set, that indicates the first run of an app to the app launched so that the app can invoke the code that is run only on a first run.

3.6.4 Synchronized Application Binding with the Local Data and Services:

An important facet of synchronized computing is to bind persistent objects of serialized internet widgets that already exist in the locally accessible storage as the ones used by a container internet widget as a member of the container widget through linked serialization. Another equally important facet of a synchronized application is to bind with the local services such as printing and the like. While in concept both actions are similar, the steps that an application goes through to bind with data objects and services are slightly different.

3.6.4.1 Binding to Local Data:

Let us say internet widget A uses internet widgets of type B and needs to locate a persistent object of serialized internet widget of type B in the local storage.

1. From the global namespace internet widget A obtains the file/data storage locations that can be searched—the data storage services have registered themselves as accessible services at the spawning of the computing utility.

2. In using these services, it searches the file storage space for serialized internet widget objects of type B either with user selection or automatic selection pick the persistent object of serialized internet widget of type B that is to be bound to the containing internet widget A and hence the associated application.

3. The internet widget A will in its widget information store the synchronization data for the selected object B.

4. It requests the access control internet widget (a TCB internet widget) to have the user update the access policy of the selected persistent object of serialized internet widget of type B to be instantiable by internet widget A. (more on this in the security section.)

5. This would complete the binding.

6. If the user grants access, then the internet widget A populates the arguments needed to instantiate the internet widget B.

Implementables:

Utility classes and internet widgets that will allow internet widgets to discover the serialized persistent object of internet widgets of a particular type (implementing interfaces etc.) and bind the application to the discovered internet widgets.

3.6.4.2 Binding to Local Services:

Unlike binding to a persistent object of a serialized internet widget, binding to a local service requires instantiation of the IVDO belonging to the virtual service internet widget prior to the binding of the IVDO to a particular IPDO that corresponds to the IVDO. In effect the persistent object of a serialized internet widget that is comprised of a virtual service internet widget is not shared by multiple internet widgets and applications as there is no intrinsic value in doing so. The search and binding of local services implemented as virtual service internet widgets is described by the following steps.

Let us say internet widget A uses a virtual service internet widgets of type B and needs to locate a registered virtual service internet widget of type B within the boundary of trust of the computing utility.

1. Internet widget A instantiates the IVDO for the service that it would like to bind to using a persistent object of the serialized IVDO.

2. If the persistent object of the serialized IVDO is obtained from outside the boundary of trust (which it will be if the application is being executed locally for the first time and is downloaded from an internet widget service provider) a dummy IVDO object is created with a failed connection to an IPDO that is either non-existent or outside the boundary of trust is not authorized to be connected outside the boundary of trust (sometimes it is permissible to connect to external IPDOs, and this is described in the section that describes security and proxification of interfaces.)

3. By inspecting the instantiated IVDO of type B, the internet widget A will know whether the IVDO is connected to a corresponding IPDO. If it is connected then internet widget A does not do anything else.

4. If IVDO is not connected to an IPDO, that is when internet widget A triggers a search in the global namespace for services that implemented the IPDO.

5. If it finds an IPDO then it will trigger the TCB access control internet widget to set up the requisite access control policy for internet widget A to connect to the user selected IPDO.

6. It then establishes the connection.

7. If an IPDO is not found application may abort if it cannot function without the service.

8. On the other hand if it can still provide meaningful functionality to the user, the internet widget A will register with the nameservice a need to informed when an IPDO of type B registers itself in the global namespace and establishes a connection when such a service becomes available.

9. In some scenarios, the IPDO may itself be instantiable by the IVDO if the IVDO has the synchronization set for the IPDO but this may not always be feasible as physical devices may need to be present inside the BOT or should be obtainable from the free pool of the computing utility pool. Even if the device is present it may not belong to the home compute set and hence may not be useful to connect to (for instance a printer or a scanner service). The user should be guided to make the appropriate selection of connecting existing device with the IPDO in the local name space, start an IPDO on a device that can be obtained from the free pool, or wait for a device to become available during the life time of the execution of the application.

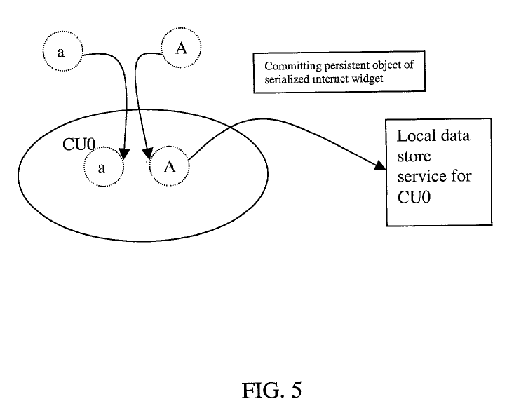

Schematically the sequence of actions in binding local persistent objects of serialized internet widgets can be represented as below in FIG. 5.

The root internet widget and its persistent object are first downloaded inside the boundary of trust and the internet widget on downloading starts creating a local containment hierarchy root for the application as the application is bound to a containment hierarchy root that is specific to the user.

Implementables:

Utility classes and internet widgets that will allow internet widgets to discover the IPDOs registered in the computing utility global name space and bind the application IVDO(s) to the discovered IPDO(s).

3.6.5 Synchronization of the Objects that Belong to the Model Plane and Visualization Planes of Execution:

As was explained in the document that describes internet widgets, each internet widget is composed instantiable distributed objects (IDOs) and these IDOs that are designed to adhere to the constraints of layered object oriented programming will belong to the two layers of execution namely the model/primary plane of execution and the secondary/visualization plane of execution. In synchronized computing that we have described so far we were treating the entire internet widget as a single software component primitive that is synchronized to be executed within the computing utility. In this sub-section we describe the specifics of where the constituent elements of synchronized computing are scheduled to be execute within the computing utility.

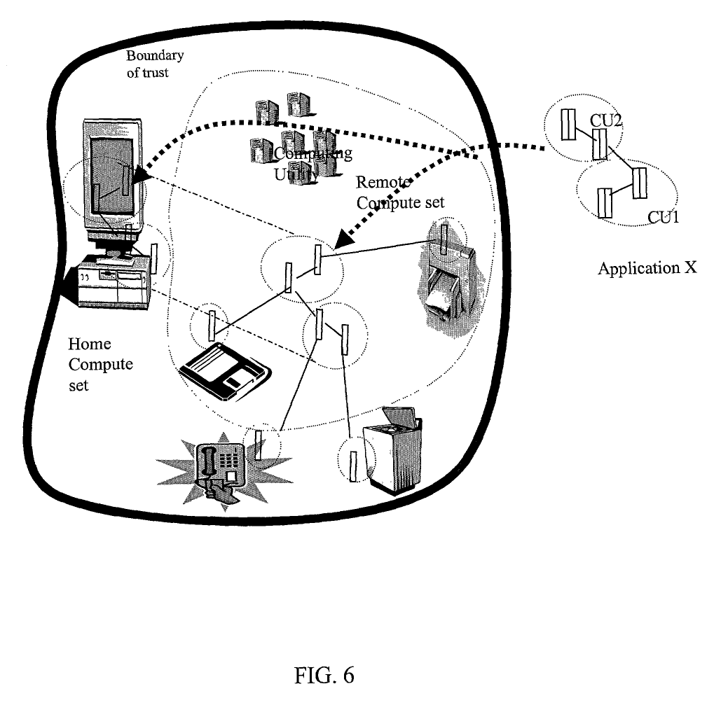

A computing utility has been partitioned into a remote compute set and a collection of home compute sets. A remote compute set is the set of computers that are allocated by the compute utility provider to a computing utility and these are not the computers that are local to the user. The devices that are local to the user belong to the home compute set. For a given computing utility there is one remote compute set and one or more home compute sets. Also, every home compute set has a display computer that can execute visualization plane instantiable distributed objects. It is this display computer that presents that graphical display for the user to interact with. As can be surmised, all the model/primary plane IDOs are scheduled to be executed on computers belonging to the remote compute set of the computing utility. Thus when an internet widget is synchronized, the primary/model IDO is instantiated on the remote compute set, and the secondary/visualization IDO is instantiated on the display device belonging to the home compute set. You can see this in FIG. 6.

3.7 Nameservice Architecture:

In order to synchronize internet widgets, the instantiation subsystem that instantiates the internet widgets and the internet widgets themselves use a name service to find various elements such as computers of certain type that an internet widget needs to have to execute or find other services that register themselves on invocation with the name service. The name service is divided in multiple elements to facilitate the creation of a computing utility that can be connected to by multiple users and devices. In this subsection we describe the nameservice architecture.

3.7.1 Nameservices Involved in Facilitating the Synchronous Computing:

One of the software service that plays a critical role in synchronous computing is the global nameservice that is shared by multiple applications within a computing utility. Name services have played very useful role in distributed computing and they will continue to play an important role in synchronized computing. Popular name service solutions in vogue are technologies such NIS, LDAP [WYET95] etc. (Note: Global here refers to the devices within a computing utility) As a global name service is critical in the functioning of multiple internet widgets, we will delve into its semantics in this sub-section.

A global name service is actually a collection of regional name services of several home computing sets and a root name service that is executed on the remote computer set of the computing utility.

A regional name service is similar to a global name service in that it is used by various applications built using internet widgets. It is different from the global name service in the fact that it is a constituent part of a global name service within a computing utility. A regional name service is the name service that is used by the home computing set before and after the home computing set joins a computing utility.

Each home computing set has one and only one regional nameservice, that can be discovered using a broadcast protocol by any network device.

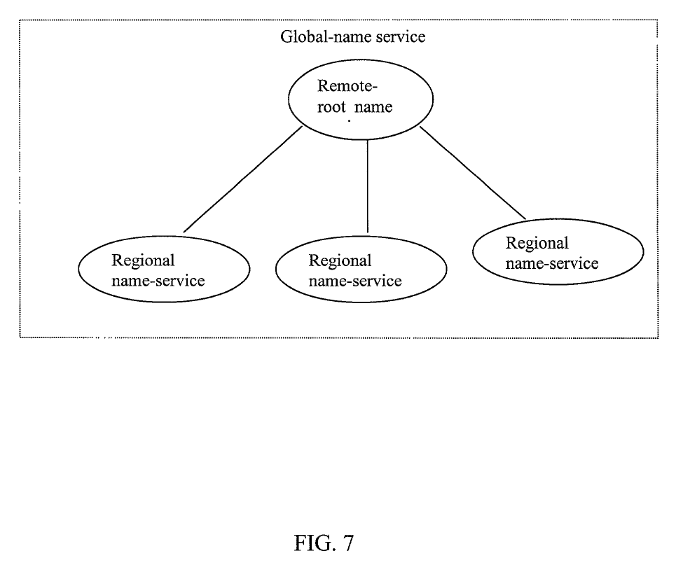

FIG. 7 is a representation of a global name service composed of several regional name services in a given computing utility.

Implementables:

Computing utility global root name service.

Home computer set regional name service.

The propagation of namespaces between regional and global name services.

3.7.2 Connecting Regional Name Service to the Remote-root Name Service:

When a home compute set is not connected to any computing utility, the regional namespace is obviously all that will be visible to the software and hardware that is in use within the home compute set. Using the protocol for registering services all the services (IPDOs) register to the regional name service. When the home compute set is connected to a compute utility using the computing utility administrator service (how the home compute set will be connected to a compute utility explained below), the regional name service is supplied the necessary information and is requested to connect to the remote-root name service. The regional name service on connecting to the remote-root name service propagates its content to the remote-root name service for all the network peers in the computing utility to have access to the newly connected regional namespace. Also, the regional namespace lookup facilities will not confine future namespace information lookups to the regional namespace once the connection is made.

3.8 Network Devices in Synchronized Computing:

As in traditional computing, synchronized computing applications can use various networked computing devices such as printers, scanners, or for that matter any device that is a network device. These network devices execute a virtual service internet widget (VSIW) as described in the internet widget document. As the concepts of synchronized computing were not introduced in explaining the concepts describing internet widgets, we had not explained the process of how the network devices obtain the code for the virtual service internet widget that they execute and the process of how they are actually launched. We do that in this subsection. The subsection sub-titled “A remote IPDO launcher” describes the synchronized computing infrastructure application belonging to the TCB and it is called by the same name. The subsection titled “The sequence for launching and registering of IPDOs on various devices” describes how network devices on power up become available for other applications to discover and use them. A significant achievement of synchronized computing is to make the networked devices interoperate with synchronized applications better than traditional computing model. Primarily, in synchronized computing the device manufacturer implements the virtual service internet widget that includes the user interface specific to the device, and multiple applications can use the IVDO to connect to the device. In traditional computing, the operating system vendor defined the interface for devices and the device drivers creators and OS vendors are typically different people, and the application vendor had to construct the UI that is appropriate for the device. The dynamic way in which the devices become available in a network, and how applications can use these devices programmatically when the device becomes available is another improvement over traditional computing. In particular, the improvement allows application developers to create programs using a distributed software object thus making the device interaction no different from interacting with any other distributed objects, while the virtual service internet widget has mechanisms to allow multiple applications to simultaneously use the device if such a usage is meaningful. Yet another advantage is the way, the network devices can use a newer version of the virtual service internet widget by synchronizing the latest version as and when there is a new one available if they chose to use a newer version of the virtual service internet widget.

3.8.1 A Remote IPDO Launcher:

A physical device that has an associated implementation of a virtual service internet widget (VSIW) and hence an IPDO will need a way for the IPDO to be launched. The implementation of the IPDO may reside on the storage that is accessible to the internet widget infrastructure that gets started as part of the device startup sequence (the core internet widget device software set). For instance a printer may store an implementation of an IPDO for the printer on a permanent storage that is bundled with the printer. This local IPDO implementation will enable the device to at minimum advertise its service to a local nameservice even if the IPDO implementation that may be available on the network is inaccessible for some reason. As we said in the previous sentence a remote implementation of an IPDO may also be present.

A device on startup has to somehow execute an IPDO that is appropriate for the device. It accomplishes this task by using a service called remote IPDO launcher. The entire startup sequence is explained in a subsequent section. We will simply go over the semantics related to the remote IPDO launcher.

The device registers with a nameservice a need for its IPDO to be launched. Every device comes with it a IPDO launch parameter list (the presence/absence of a local implementation of an IPDO, the known remote locations where the implementations of current and future versions of an IPDO may be found.) The remote IPDO launcher listens to the name service to see if there are any new requests for an IPDO to be launched. On getting a request, the remote IPDO launchers uses the parameter list to trigger the invocation of the IPDO on the device.

The remote IPDO launcher is part of the core internet widget network software set.

The advantage of using a remote IPDO launch an IPDO on the device instead of the device launching it itself is in the fact that a device may not have a local IPDO implementation packaged with the device, and the remote IPDO launcher can check to see if a newer version of an IPDO is a preferred IPDO to be launched for the device.

Implementables:

A Remote IPDO Launcher.

3.8.2 The Sequence for Launching and Registering of IPDOs on Various Devices:

Even before the home compute set is connected to the compute utility, the various devices and their corresponding IPDOs may need to register their location information with a name service that can be accessed by all the devices in the home compute set. The following sequence of events take place in order to facilitate the registering of IPDOs.

1. The regional name service is already started up prior to the starting of any other device or service IPDO.

2. The home compute set may or may not yet be connected to a compute utility.

3. The devices execute the device os/network protocol/internet widget core software.

4. The devices after startup locate a name service by locating broadcast messages from the name services(which will be the regional name service if the home compute set has not yet been connected to a computing utility, or it could be any number of regional nameservices that may be connected and broadcasting their presence in the network).

5. Then the device will pass to the remote IPDO launcher the data needed by the remote IPDO launcher to determine the location alternatives of the implementation of the IPDO to be remotely instantiated on the device. (This data is packaged with the device on firmware or some other storage medium accessible to the core internet widget device software) The device registers its need for starting an IPDO with the name service.

6. Any instantiation of an IPDO will involve the registration of the IPDO with a nameservice.

7. They then register themselves to a name service, and this registration will enable access of this device and its service to all other devices and applications executing in the network.

Implementables:

Specify the Core Internet Widget Device Software Set.

3.9 Home Compute Set Usage:

The way home compute sets are connected to the remote compute set of the compute utility is explained in this subsection.

3.9.1 The Home Compute Set Gateway:

The home compute set is connected to the internet using one of the existing modem technologies such as ISDN, DSL, cable modem etc. The connection to the internet allows the home compute set to be visible to the internet directly, and this would make the home compute set vulnerable to security exposures of the internet. In order to preserve the rigid trust that is expected within a boundary of trust, the home compute set on requesting to be connected to a compute utility routes the access of devices in the home compute set to the internet through the compute utility infrastructure. In order to make this possible, the home compute set needs one home compute set gateway.

The home compute set gateway may or may not be a dedicated device. Home compute set gateway runs two software applications. They are:

1. Compute utility connecting software

2. Virtual Private network connecting software

Home compute set gateway on startup:

As home compute set gateway is yet another device, and since it needs to function prior to connecting to a compute utility it invariably registers its service with regional name service.

Another action that the home compute set gateway does is register with the regional nameservice provider a desire to execute the compute utility connecting software on every display device (a device that a user can use to interact with various applications). The compute utility connecting software is an application that is implemented using internet widgets, and one of the internet widgets service it uses is the compute utility administrator service. The application can take the connection parameters and connect to a compute utility providers administrator service. This application allows users to connect the home compute set gateway to a named compute utility that has either already been created or will be created based on this request for connection by this home compute set.

Based on the request sent by the compute utility connecting software, the compute utility administrator service will send the necessary parameters that can be used by the gateway to connect its home network only to the private network server that is run as part of the compute utility core internet widget network software. The compute utility connecting software now initiates on the home compute set gateway “Virtual private network connecting software” application. This software connects home compute set gateway to a virtual private network that is accessible only to devices within the boundary of trust of the computing utility. All access to the networks outside the compute utility boundary of trust after this step is routed through the compute utility gateway computers.

Implementables:

Compute utility connecting software that connects home compute set gateway with the computing utility by contacting the compute utility provider.

3.10 Computing Utility Creation, Administration and Management:

The computing utility that is at the center of synchronized computing is itself created when a user requests one to be created. In this sub-section we will describe the creation, administration and management.

3.10.1 Spawning of the Computing Utility:

A compute utility is spawned when a home compute set gateway requests the compute utility administrator service for the first time to be connected to the named compute utility it has subscribed to use from the compute utility provider. Whenever a computing utility is spawned a collection of devices that will belong to the remote compute set of the computing utility are allocated by the computing utility provider. As part of the spawning of the computing utility several software applications that belong to the core internet widget network software stack are executed. The applications include a root remote-nameservice that aggregates the namespace for the compute utility, the VPN server whose connection parameters are maintained by the compute utility provider that passes this information to any requesting HCS gateway that wants join the private network of the compute utility. It also starts the compute utility gateways that enforce the policy of protection for the boundary of trust. These are some of the software applications that get launched at the spawning of the computing utility. These may not be all implemented using internet widgets.

Implementables:

Compute utility provider software—that manages requests for connecting with a computing utility.

Compute utility provider software—that manages requests by computing utilities for allocating computers of particular types from the free pool.

Compute utility provider software—that manages requests by computing utilities for committing computers of particular types from the computing utility to the free pool.

All the computers added to the computing utility by the computing utility provider run a “Boundary of trust” application that ensures that communication between the computers inside the boundary of trust is permitted, while the access to computers outside the boundary of trust are limited to downloading data and code.

3.10.2 Dynamically Expanding and Shrinking the Computing Utility Capacity:

Synchronized computing makes it possible to add computing capacity to the computing utility dynamically. Considering there is absolutely no expectation by the synchronized applications on the nature of the hardware and software that facilitates synchronized computing, it is possible to allocate and de-allocate the computers that are part of the computing utility. A load monitoring software can request the computing utility administrator service to connect one of the computers from a free pool of computers to the computing utility. The free pool computer becomes a vpn client to the vpn server belonging to the computing utility, thus enabling the computing utility to use the additional computer to run the internet widgets that are synchronized to be executed on the computing utility. When the load monitor discovers a lack of usage it can commit the computers back to the free pool. In future it may be possible to dynamically consolidate fragmented load in order obtain better utilization of the computers.

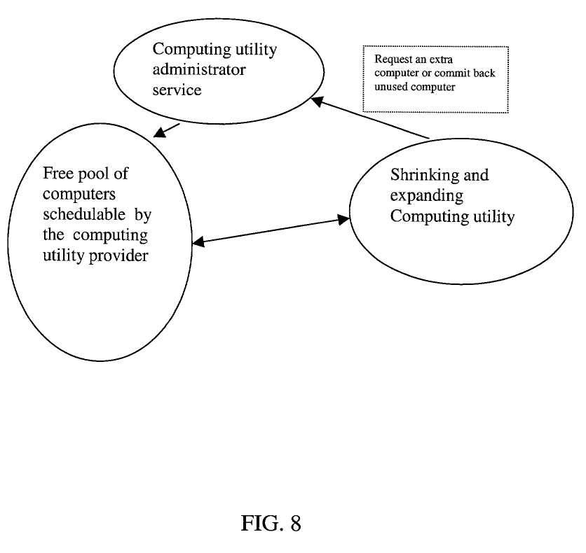

This capacity to dynamically increase and decrease the computing power for the users of software solutions makes synchronized computing a compelling solution to improve the resource utilization. FIG. 8 shows the various elements of managing the computing utility as the load is fluctuating.

Implementables:

Load monitoring software that executes on the remote compute set computers on the computing utility, to increase and decrease the computing power.

3.11 Plausible Usage Models of Connecting Home Computing Set to a Remote Computer Set Supplied by a Computing Utility:

Scenarios that may be considered useful in connecting the home computing utility set with a remote computing utility are as follows.

1. The home computing set provides some useful functionality even when it is not connected to any computing utility

2. The home computing set is largely unusable unless it is connected to a computing utility.

The distinction between the above two configurations is in the number of applications that use these devices that can be used when not connected to a computing utility over the internet. If several applications need to be both accessible and executable, then it is necessary for the home computing set to have in its midst various virtual service internet widgets that facilitate this. For instance a data storage/file service that can store both the implementations and persistent objects of internet widgets that get synchronized have to be stored in some location. An application launcher needs to be executed on every display device to enable users to launch applications from the storage space.

The second scenario requires a subset of functionality for the whole solution to work, we will defer the specification and implementation of the first set to a later stage.

3.12 Special Initial Startup Sequence for Display & UI Computers:

The display computer that users interact typically will belong to the home compute set. It is the display computer that a user uses to invoke synchronizable applications. In order for the users to be able to do that, the display computer should have the capacity to navigate the data space that store the synchronization set as stored in a data/file storage accessible from the global name service. Either the regional nameservice or the data/file storage or the global name service will have to start an application that then can be used to launch all the other synchronizable applications. As soon as a display computer registers itself to the namespace, the application navigation and launching application are invoked for the user to invoke additional applications.

Implementables:

An application launcher that runs on a display/UI computer in a home compute set.

Security in Synchronized Computing:

Synchronized computing as specified so far has two significant security implications. One, it requires additional infrastructural support to create secure applications. Two, it makes it possible to create applications that have more desirable security attributes than many of the well known paradigms of computing. We will first address the additional infrastructural support issues of synchronized computing, and in a subsequent section describe how applications with more desirable security properties can be created using synchronized computing while detailing what the desirable properties are.

3.13 Additional Infrastructure Support for Improved Security in Synchronized Computing:

In this sub-section, we will first enumerate the desirable features needed in synchronized computing that have a bearing on security infrastructure of synchronized computing. We will follow this enumeration with analysis for each of the desired features that describes the plausible security vulnerabilities in synchronized computing in the absence of infrastructure improvements to the synchronized computing infrastructure. And, for each of the plausible vulnerability we provide the infrastructure enhancements necessary to improve the security.

3.13.1 Desirable Features of Synchronized Computing that Have a Bearing on Security Infrastructure of Synchronized Computing:

The motivation for improved infrastructure support in synchronized computing are the following desirable features of applications that are developed in the synchronized computing model.

1. The code or executables can be obtained from sources outside the boundaries of trust during the run time, and from disparate sources that application creators gathered their internet widgets that they used in building their applications.

2. The code dynamically obtained from outside may operate on data that is owned by the user who triggers the invocation of the application. (This ability is a desirable property for applications obtained from outside boundaries of trust.)

3. The code dynamically obtained from outside may establish connections with IPDOs that are outside the boundary of trust for the user.

The synchronized computing security infrastructure will attempt to mitigate the harm that can be caused by applications that have the above requirements. Some of the techniques that will be used by the infrastructure are already in vogue.

For each of the above feature requirements to be supported in synchronized computing, we will have to first look at plausible problems that may create security vulnerabilities, and then device techniques that mitigate these vulnerabilities.

3.13.2 Plausible Security Vulnerabilities with Feature Number 1 as a Requirement of Synchronized Computing:

1.0 Secure traceability of application/internet widget developers. Hostile and malevolent application developers may create applications that may perform undesirable and unspecified actions within the boundary of trust. These may include unspecified operations that are described in the motivations numbered 2 and 3. The presumption here is that the activities described in motivations numbered 2 and 3 are quite acceptable if the user using the application explicitly grants the privileges necessary for performing these operations in a manner that does not significantly hamper the usability of the applications. In the days when there were few application development companies and individuals developing applications it was easy to trace the sources of malevolent applications performing unspecified and undesirable activities. This however is not very easy any longer as significant functionality is being developed by multitudes of application developers that are hard to trace.

3.13.3 The Synchronized Computing Infrastructure Support to Address this Problem is:

Signed Internet Widgets.

(This technique is already in use for ordinary applications.) We will not dwell into the specifics of how signed apps address the above vulnerability. The reader is referred to literature on signed applets [SUNM97] that is widely available.

Implementables:

Internet widget (IDO) instantiation verifies the signature of the signed internet widget before instantiation.

3.13.4 Plausible Security Vulnerabilities with Feature Number 2 as a Requirement of Synchronized Computing:

3.13.4.1 Unauthorized Access by Downloaded Applications of Internet Widget Persistent Objects on Storages within the Boundary of Trust.

In traditional computing, the model used to protect data was the one that allowed applications launched by a user to all the data that is owned by the user that may have been created by another application. In this model it was difficult to prevent one application from accessing the data created by another application for the same user. While this is an adequate and convenient model if the user has equal trust for all the applications that are executed by the user in accessing all of her data. However if the user trusts one application more than the other in accessing certain data, then the current model falls apart. It is not inconceivable that a user that a purchases a banking application from a trusted source uses that application to create financial data and a medical application to maintain her medical data. Another application that a user obtains to edit pictures is not expected by the user to access and operate on the user data or even remove the internet widget persistent objects created and operated by the financial and medical applications. (This particular exposure is currently exploited extensively by e-mail virus creators.)

3.13.5 The Synchronized Computing Infrastructure Support to Address this Problem is:

3.13.5.1 User/Application as the Principal for Access Control Policy:

The above described problem exists primarily due to the fact that all access control policy of protecting data resources historically has been built around the abstraction that a user is the primary principal around whom the semantics of protecting resources are built. This is true in simple access control techniques used in UNIX like operating systems, such as file permissions and access control lists (ACLs) to more sophisticated ACLs used in distributed computing that are role based. Since applications and internet widgets are in effect proxies to the user, it is plausible for one proxy to be more trustworthy than another for a user based on the user's sense of trust. For instance an application downloaded from a hacker's web site may not be as good a proxy as an application that user purchases from company that is publicly traded and relies on its reputation to provide secure software or an application whose source code is open source. Also, the user may chose to partition some data to be accessible to any application while not allowing others as in the example given in the description of plausible vulnerabilities. In order to facilitate different policy for different applications or internet widgets invoked by the same user the access control internet widget that allows the data sources to define policy and protect access makes it possible to define access policy for a {user,application(iw)} principal.

A more detailed definition of the access control policy syntax and semantics is described in a document separately dedicated for that purpose. But for the purpose of illustrating the solution we will define a simplified description of the access control policy element for a given persistent object of a serialized internet widget. The following table defines the policy for one such internet widget persistent object.

| principals/actions | Read | Update | delete |
|---|---|---|---|
| Shankar, banking | Yes | Yes | yes |
| iw | | | |
| Shankar, medical | Yes | Yes | yes |
| iw | | | |
| Shankar, hackapp | Yes | No | no |

The policy table for a persistent object of a serialized internet widget. The above structure can be extended for other familiar access control abstractions such as roles and rules, discretionary and mandatory policies.

Initialization of Access Control Policy on First Time Access to a Persistent Object of a Serialized Internet Widget.

In the case of synchronized computing using internet widgets, an internet widget that has been created by an application may become the data element of another application. A typical scenario is one where a user triggers a synchronizable application for the very first time and the highest level internet widget and its persistent object used for initial use are downloaded inside the boundary of trust and the internet widget is instantiated. On instantiation it may either download additional internet widgets and the corresponding persistent objects or try and locate other persistent objects that have been created by other applications in the users file/data storage space. The sequence of steps that an internet widget goes through in order to bind to an existing persistent objects of serialized internet widget or a local virtual service internet widget has been described in an earlier section. One of the steps that happens during the binding to a persistent internet widget created by another application is the invocation of the access control internet widget that allows the user to grant access to the new application data created by another application/internet widget that belongs to the user and the user can give access to. Since the access control internet widget belongs to the trusted computing base, it will not be feasible for malevolent manipulation of the policy data by an external application that is not already trusted by the user or the computing utility.

The benefit of having the user grant access to specific data elements to an application is that external applications will not have the capacity to maliciously destroy/corrupt all user data the user does not suspect the application to change. A strategy that can diminish data loss caused by viruses. Since the policy is to be mandatorily set only once the inconvenience of granting access is limited only to the first time invocation. Also, the applications will not be able to access unauthorized data if they have not been granted access in the first time invocation and will be forced to execute the access control policy internet widget every time they attempt to access a data element to which they have not been granted access. This will be enforced by another TCB internet widget, the data/file storage service internet widget.

Implementables:

The user/application based access control policy creation and verification by the TCB internet widget.

3.13.6 Plausible Security Vulnerabilities with Feature Number 3 as a Requirement of Synchronized Computing:

3.13.6.1 Pilfering of Data that Has not been Authorized to te Sent to an External IPDO.

When a user points their application launcher to an internet widget service provider to use the root synchronization set of the application to download the applications to be executed inside the computing utility, the downloaded application can perform its computing with the data that is downloaded from inside and outside the boundaries of trust of the computing utility. However there can be situations in which the downloaded application may have to send data outside the boundary of trust to complete the computation. Imagine for instance there is an application that helps a user purchase a book. In order for the user to browse through the selection of books in synchronized computing where the data only comes from outside the boundary of trust and does not leave the boundary of trust, the book publisher may need to keep the entire book catalogue and pricing information as a persistent object of a serialized internet widget to be downloadable into the boundary of trust of a computing utility. This may not be an acceptable model for various business reasons and performance reasons. A more acceptable may be one where the book vendor creates an virtual service internet widget and uses the IVDO of the service internet widget with the application that is downloaded into the computing utility and this in turn selectively sends and receives data from the IPDO that the IVDO connects to. Until now we said that internet widgets downloaded from outside the boundary of trust cannot send any data outside the computing utility as the computing utility gateway does not permit the applications downloaded to establish connections to the outside world. However synchronized computing will need to make it possible for data to travel between the boundaries of trust to fully exploit the computational possibilities within the constraints of business and performance needs. As the applications that come from the outside are capable of malicious activities if unfettered access is provided for data to move between the boundaries of trust, it is necessary to impose the requisite security constraints in a manner that does not restrict benevolent computing while restricting malevolent computation by hostile applications. The steps taken to limit access to the local data and insisting on executing identifiable applications is a mechanism that provides some protection. To further improve the ability of the user to control how they would like the data to be sent outside the boundary of trust, and what data can be sent outside the boundary of trust we create another security mechanism that lets the user of the application determine the policy of sending data outside the boundary of trust. This mechanism is called the proxification of interfaces and is described below.

3.13.7 The Synchronized Computing Infrastructure Support to Address this Problem is:

Synchronized computing solves this problem using a technique invented for this special purpose. This technique is called the proxification of interfaces. Due to the complexity and the amount of detail that needs to provided to explain this technique we have chosen to write a separate section to solve just this problem.

4.0 Proxification of Interfaces, a Security Technique:

In this section we describe the security technique of the proxification of instantiable distributed object interfaces. The primary purpose of the technique proxification of interfaces is to prevent the pilferage of user data from within the boundary of trust to outside the boundary of trust. In order to proxify instantiable distributed object interfaces, there is some new infrastructure that is specified which will facilitate in the process. This section begins by describing the background for proxification of interfaces by defining the restrictions on communication across the boundary of trust, and some important characteristics of the instantiable distributed object interfaces. The rest of the section is organized into the following subsections:

Proxification of interfaces using IDL files

Conversion of IDL files to proxy binaries in proxification

Event Handling in proxification

The workflow semantics of proxification

The process of converting a backward IDL file to a ClientIPDOGateway binary

Modifications to the computing utility infrastructure to facilitate proxification

The invocation sequence of the ClientIVDOGateway

Exporting a service and namespace to distributed objects outside the boundary of trust in a computing utility

4.1 Background for Proxification of Interfaces:

When internet widgets are downloaded from internet widget service providers outside the boundary of trust of a computing utility, these internet widgets may be simple internet widgets or virtual service internet widgets. In order to provide requisite trust of communication between the internet widgets executed inside the boundary of trust and external computing resources we impose following restrictions.

4.1.1 The Restrictions on Communication Across the Boundary of Trust are:

1. Simple internet widgets do not directly use any primitive network middleware (sockets etc) to communicate with computing resources both inside and outside the boundary of trust. (the computing utility gateways are configured to not allow any traffic to pass through the gateway.) Using primitive network middleware within the boundary of computing utility may lead to violations of layered object oriented programming.

2. Whenever two computing peers are separated by the boundary of trust, the two peers on the two sides of the boundary of trust are an IVDO and an IPDO of a virtual service internet widget. The IVDO that will be part of the application execution context will be within the boundary of trust and the IPDO may or may not reside inside the boundary of trust.

From the above restrictions, it is clear that any communication across the boundary of trust is defined by the interface definition that facilitates communication between an IPDO and an IVDO of a virtual service internet widget. It is the proxification of this interface that will help us improve the degree of trust a user has in being protected from malicious pilfering of the user data while still facilitating useful computation. Before we describe the theory behind the proxification of interfaces we will briefly enumerate some significant characteristics of interfaces between distributed object peers that are relevant to our discussion.

4.1.2 Significant Characteristics of Distributed Object Interfaces:

1. Distributed object interfaces can be formally described using interface definition languages more commonly known as IDLs.

2. Interfaces typically describe the methods that the client object invokes on the server object.

3. Events that are delivered by a server object to a client object also define the communication that takes place between the two peers and this can also be formally described extending the interface definition language. The syntax can be as simple as {event from the server, eventhandler interface of the client}

4. The two peers, in our case IVDO and IPDO can reverse roles as server and client in keeping with the coupling between layered objects i.e an IDL defining the IVDO interface can be used by the IPDO to invoke methods executed by I VDO if the IVDO supplies a reference to the IPDO.

From the above features we glean that it is possible to have two distinct IDL files that define IVDO to IPDO (method,event) communication and IPDO to IVDO (method, event) communication. We call the first of the two IDL files the forward IDL file, and the second the backward IDL file.

4.2 Proxification of Interfaces Using IDL Files:

This subsection describes the proxification of interfaces using IDL files, we will first describe the forward and backward IDL file. We will then provide an overview of the proxification process. We will also describe the binaries that are created as part of the proxification.

4.2.1 Let us Now Describe the Forward IDL File and Backward IDL File:

As we have described earlier, the objective of proxification of the interfaces between an IVDO and the corresponding IPDO is to improve the level of trust a user has of the communication between these two peers. The expected improvement in the level of trust is above and beyond the granting of permission in the access control policy space for the IVDO to communicate with a particular IPDO.

Let us for the purpose of illustration use the following interface definition to describe what is the desired improvement in trust that proxification is expected to achieve.

Public interface remoteService{

RetumObject1 method1(ArgObject1, ArgObject2);

RetumObject2 method2(ArgObject3, ArgObject4);

[serverEventl clientEventHandlerInterface]

}

Note: The syntax of the event definition in an IDL file is primitive and is used for the purpose of illustrating the usefulness of proxification. A more thorough but routine description of the grammar for defining events will complete the specification of proxification.

4.2.2 Proxification Overview:

The above remoteService interface is implemented by an IPDO and the IVDO invokes the methods to do some useful computation and listens to the events delivered by the IPDO to do some useful work. If the IPDO is instantiated within the boundary of trust, then the user need not worry about what data is sent by the IVDO to an IPDO as all the elements inside the boundary of trust are trusted by the user. On the other hand if the IPDO is outside the boundary of trust, then the user may want to control and view the communication between the IVDO and the IPDO. If there was a way for the user to request some entity to display the arguments that are passed between the IPDO and the IVDO and the return object then it may be possible for the user to determine if unauthorized data is being transferred by the IVDO to the IPDO. Similarly, the user will be able to monitor what actions are being triggered by the events delivered by the IPDO if the events can be observed. This is the improved feature that would improve the amount of trust a user has on the communication of IVDOs with external IPDOs. We will in this section describe how a user will be able to do the above.

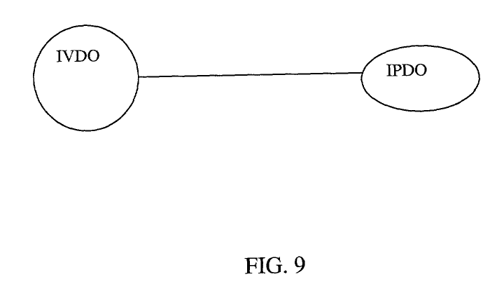

In un-proxified communication between an IVDO and an IPDO the following picture FIG. 9 depicts the communication.

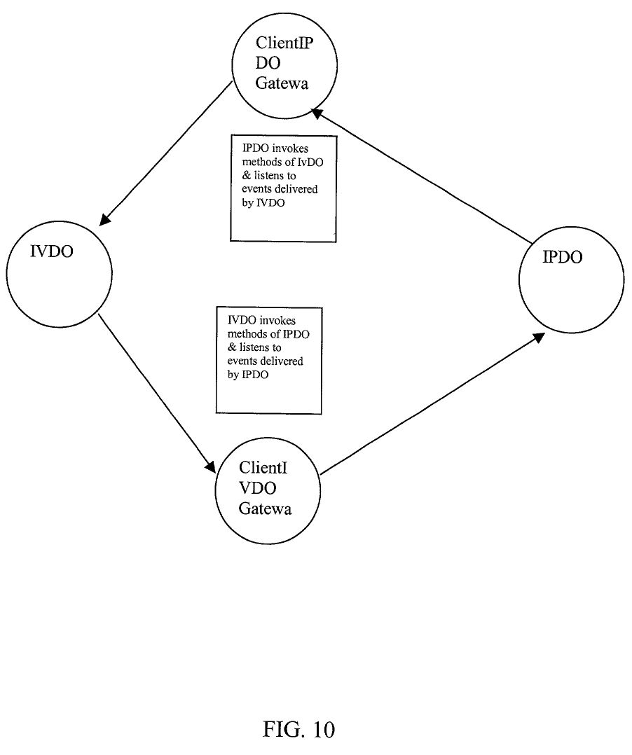

The proxified communication between an IVDO and an IPDO pictorially can be represented as shown in the FIG. 10.

At a very high level proxification involves the following steps:

1. The proxified IVDO & IPDO pair is packaged differently

a. The binary package that comprises of the IVDO class implementation includes the forward IDL file and the backward IDL file that define the interface between the IvDO and the IPDO.

2. When the virtual service internet widget is downloaded for synchronization the IDL files are also downloaded into the computing utility.

3. Prior to the instantiation of the internet widget and hence the IVDO, the instantiation sub system will create a IVDO to ClientIVDOGateway tunnel and a ClientIPDOGateway to IVDO tunnel using the IDL files. The ProxificationIDLCompiler (belonging to the TCB) will create the ClientIVDOGateway and ClientIPDOGateway binaries. (this is described in greater detail below.) They are called the ClientIVDOGateways as these are created to protect the client side computing done by the client objects IVDOs. A similar protection technique is used to secure server sided computing performed by the IPDOs, and they too use gateways to control access within the boundary of trust in a computing utility where they are executed.

4. The ClientIVDOGateway object is instantiated by the remote instantiation subsystem (belonging to the TCB) that is already executing on each of the computing utility gateway computers.

5. The IVDO connects to the ClientIVDOGateway as it would connect to the IPDO and ClientIVDOGateway is effectively the proxy for the IPDO.

6. The ClientIVDOGateway will invoke a monitoring internet widget that initiates a UI conversation with the user asking what the user would like to monitor.

7. The ClientIVDOGateway in turn will establish a connection with the IPDO.

8. The ClientIVDOGateway traps all the method invocations to the IPDO and based on the monitoring and control policy established by the user do the appropriate action prior to invoking the corresponding IPDO method.

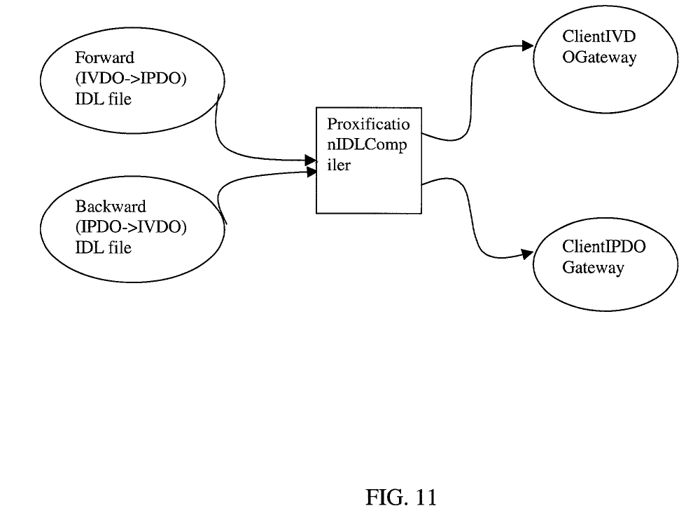

The generation of a ClientIVDOGateway and a ClientIPDOGateway from the forward IDL file and the backward IDL file as depicted in FIG. 11:

Traditional distributed object computing typically utilizes IDL compilation to create the stubs for the client and server objects in order to simplify the programming effort for developers. In synchronized computing we extend the semantics of the IDL compilation to facilitate proxification of interfaces. In traditional IDL compilation the IDL file is processed to create the source code necessary to marshal the arguments between the client and the server objects. A subsequent compilation of the IDL compiler created stub source code with the actual client source code together creates the client binary.

The ProxificationIDLCompiler on the other hand takes as input a forward IDL file and creates a ClientIVDOGateway binary.

The ProxificationIDLCompiler takes the backward IDL file and creates a ClientIPDOGateway binary.

The ClientIVDOGateway and ClientIPDOGateway are two instantiable distributed objects or IDOs.

We will first describe the process of converting a forward IDL file to a ClientIVDOGateway binary, and follow that up with a description of the process involved in converting a backward IDL file to a ClientIPDOGateway binary.

4.3 Conversion of IDL Files to Proxy Binaries in Proxification:

(The process of converting a forward IDL file to a ClientIVDOGateway binary)

In this subsection we will describe the conversion of IDL files to the proxy binaries that actually protect in the communication of peer distributed objects on different sides of the boundary of trust. We will focus our attention on converting the forward IDL file to ClientIVDOGateway binary. The exact methodology is used in converting backward IDL file to a ClientIPDOGateway binary.

Before we describe the actual process of converting a forward IDL file to a ClientIVDOGateway binary, we would like enunciate a few relevant statements.

The primary objective in creating the ClientIVDOGateway binary is to make it possible with some code that is not downloaded from outside to interpret the users policy for monitoring the arguments and return values that are passed around between the IVDO and the IPDO that is outside the boundary of trust of the computing utility.

Since the internet widget service provider only supplies the IDL file, and not the monitoring policy that is established by the user, the external application executed within the boundary of trust of the computing utility will not be able to transfer data to an external IPDO without the users consent if the user policy is enforced by the code that is not downloaded.

When the application in question is downloaded for the very first time, there will not be any monitoring policy for a given forward IDL file belonging to a specific IVDO. This policy creation step is performed when the IVDO invokes any method of the ClientIVDOGateway object for the very first time.

The ClientIVDOGateway needs to be uniquely identified in the monitoring policy table in order to not require the user to create a new policy every time the user application instantiates the IVDO and as a consequence instantiates ClientIVDOGateway. The way to solve this problem is by making ClientIVDOGateway generate a UUID (refer to any UNIX documentation to learn what a UUID is) as the ClientIVDOGateway identifier within the given computing utility and stores this in the persistent object of the serialization of the internet widget for subsequent invocations of ClientIVDOGateway binary. The ClientIVDOGateway binary is generated by the ProxificationIDLCompiler and it generates the source code and the consequent binary in such a way that the ClientIVDOGateway identifier field is set to a value such as 0 that will let the ClientIVDOGateway binary in runtime to discover that the ClientIVDOGateway identifier has not been set to a valid UUID and triggers this self naming step.

Let us consider the example forward IDL to explain the process of creating the ClientIVDOGateway binary.

Public interface remoteService{

ReturnObject1 method1(ArgObject1, ArgObject2); [self reference objects: ArgObject2]

ReturnObject2 method2(ArgObject3, ArgObject4);

[serverEvent1 clientEventHandlerInterface]

[connectionInformation to connect to IPDO]

}

The above forward IDL file is the input to the ProxificationIDLCompiler.

Without the proxification step that is unique in synchronized computing the forward IDL file is used to create the distributed object server skeleton and the client stub so that the various arguments and the return objects are marshaled between the server object and the client.

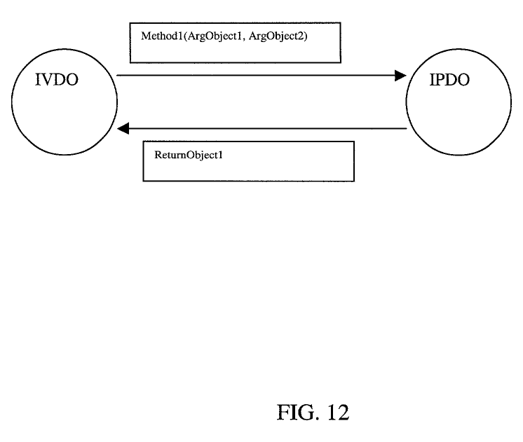

Un-proxified communication between an IVDO and IPDO for a sample invocation of the method method1 is shown in FIG. 12.

The ClientIVDOGateway object created by the ProxificationIDLCompiler is an intermediate object that all the IVDO calls to the corresponding IPDO are routed through. Similarly the events that IPDO wants to deliver to IVDO are also routed through the ClientIVDOGateway object.

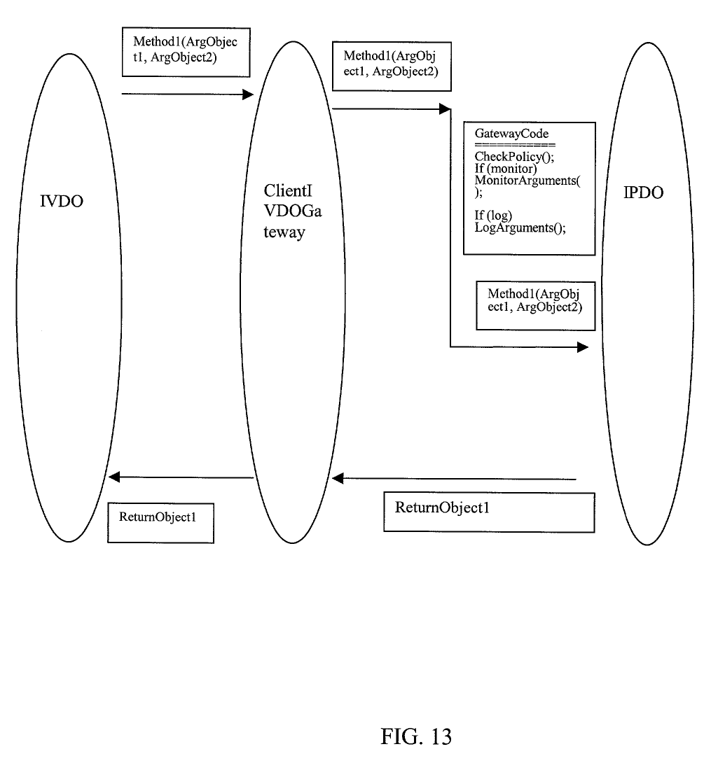

Pictorially as shown in FIG. 13 a method call for method1 from the IVDO to the IPDO that is routed through the ClientIVDOGateway object.

One of the objectives of routing the method call of an IVDO through the ClientIVDOGateway is to trap the invocation of a method call and execute the Gateway code that is inserted by the ProxyIDLCompiler prior to invoking the actual method call that is to be executed by the remote distributed object IPDO. The ClientIVDOGateway method with the name Method1 that gets invoked on invocation of IVDO Method1 call is called the proxy method. We will describe in greater detail the semantics of the compiler generated Gateway code that is executed to build trust in the communication channel between the IVDO and IPDO. Before we do that, we would like to make a few observations.

Observations About the ClientIVDOGateway:

1. The ClientIVDOGateway is a distributed object server that mimics the methods and events that are actually implemented by the IPDO. In other words, the IVDO is a distributed object client to the distributed object server implemented by the ClientIVDOGateway.

2. The ClientIVDOGateway in turn is a distributed object client of the actual distributed object server implemented by the IPDO.

The ProxificationIDLCompiler thus takes the forward IDL file and creates the ClientIVDOGateway as a distributed object server that implements the interface defined by the distributed object server remoteService. It parses the remoteService forward IDL file uses the definition of the methods in the interface to create the server stub & the client code quite similar to a conventional IDL compiler. Besides the creation of the server stub, it also inserts the gateway code in each of the methods implemented by the forward IDL interface. This gateway code is invoked when any of the methods of the remoteService are invoked.

4.4 Event Handling in Proxification:

4.4.1 Event Handling by the ClientIVDOGateway:

With regards to events, the eventHandlerInterface that implements the methods that are invoked by the event source are replicated in ClientIDOGateway. In other words in traditional event based computing, the IPDO would expect IVDO to implement a particular eventHandlerInterface in order for it to register and listen to the events delivered by the IPDO. Considering the IPDO does not directly communicate with the IVDO, the ClientIVDOGateway simultaneously becomes an event source to the IVDO and an event listener to the IPDO. The ClientIVDOGateway in effect implements the eventHandlerInterface and registers to listen to the events delivered by the IPDO. The methods of the event handler interface are quite similar in character to the proxy methods that ClientIVDOGateway implements. They too execute the gateway code for security house keeping and then become event sources to the IVDO. The IVDO registers as an event listener to the ClientIVDOGateway instead of listening to the events directly from the IPDO. The ProxificationIDLCompiler parses the forward IDL file to generate the event handling proxification code without any manual programming by any developer. The forward IDL file need to contain the necessary information for the ProxificationIDLCompiler to be able to create this code.

4.5 The Workflow Semantics of Proxification:

In this subsection we will describe the workflow semantics of proxification. When the ClientIVDOGateway binary executes, it needs to do certain specific tasks in order to achieve its objective of protecting the pilferage of data to the world outside the boundary of trust while it also facilitates the requisite communication. In that regard, we will describe how references of IVDOs are passed to the IPDOs in order for IVDOs to connect with the IPDO. Subsequently we describe how the code known as “gateway code” is inserted into the proxies to accomplish the security auditing and monitoring necessary. One important technique used in monitoring unauthorized transmission of data within the boundary of trust to the outside world is by forced visualizing of the data by the proxy binaries. Finally we describe the way connections between the communicating peers on the two sides of the boundary of trust is enabled.

4.5.1 Passing a Reference of the IVDO to the IPDO:

With virtual service internet widgets the IVDO may in some methods pass a reference of itself to the IPDO in a given method in order for the IPDO to invoke some calls such as visualization of a dialog to get some information from the user. Since the IVDO method invokes the ClientIVDOGateway instead of the IPDO directly, it is necessary to pass the correct reference so that the IPDO may invoke the appropriate method of the IVDO.

We specify that these arguments be referenced as self reference objects and are identified in the forward IDL file. The ProxificationIDLCompiler will substitute the reference to the ClientIPDOGateway instead of the IVDO so that the IPDO can invoke the methods of the IVDO. Since the name of the ClientIPDOGateway that is used in registering with the application namespace is known to the ProxificationIDLCompiler it can create the appropriate reference to be passed to the IPDO. This is the instance which necessitates the backward IDL file that is used to create the ClientIPDOGateway. The reverse IDL file defines the interface implemented by the IVDO.

4.5.2 The Gateway Code:

The gateway code is the code that gets inserted in the ClientIVDOGateway methods and event handler interface methods to facilitate the creation of a monitoring policy and adherence to the monitoring policy. The monitoring policy semantics are restricted in such a way that user can only define the types of policies for which the automated code generated by the proxificationIDLCompiler can adhere to the policy and are sufficiently simple for any user to create a policy. Some example policy semantics that can be created automatically are, log all the arguments of the methods that are implemented by ClientIVDOGateway, or visualize all the arguments of the methods that are implemented by ClientIVDOGateway. The policy may offer other choices such as logging and visualizing the first few exchanges, or random invocations or even periodic invocations. If the policy states that the arguments are to be logged, then the gateway code will log them in the logging location that user can select.

4.5.3 The Visualization of Arguments:

Arguments are visualizable if the arguments are internet widgets. As we described in the internet widget definition the primary/model plane object will have interfaces that can trigger visualization plane objects that let the user view the data represented by the primary plane object in some meaningful visual form. Thus if the user requested to visualize arguments of a particular method in the policy, the gateway code interprets this policy and invokes the internet widget visualization calls in order to let the viewer observe what data is shipped out to the IPDO by the IVDO.

All of the gateway code is generated by the proxificationIDLCompiler. In order to be able to accomplish this, the specification of the gateway code, the plausible policies and their semantics for monitoring the data exchanges need to formally specified using a grammar that can then be used by the proxificationIDLCompiler. This will happen as part of the implementation effort.

4.5.4 Setting Up the Connections:

The developer of the synchronized application that is being downloaded does not apriori know the connection information necessary to connect to the ClientIVDOGateway. The persistent object that may be associated with the serialized IVDO downloaded with the application at most may point to the IPDO, and since the IPDO is outside the boundary of trust of the computing utility the IVDO will not be able to reach the IPDO directly. The application developer using an IVDO that will connect to IPDOs external to the boundaries of trust of the computing utilities will need to bind to the ClientIVDOGateway. As explained in internet widget instantiation the name used by the ClientIVDOGateway is decided by the application developer using the name collision avoidance technique and the proxification ClientIVDOGateway will register itself in the application namespace with the given name and thus enabling the IVDO to bind with the ClientIVDOGateway.

The forward IDL file will contain the connection information necessary for the IVDO to connect to IPDO. Since the application developer knows which IPDO the IVDO may chose to connect with, this information can be packaged with the forward IDL file. This information is used in creating the code necessary by the ClientIVDOGateway to connect with the IPDO.

4.6 The Process of Converting a Backward IDL File to a ClientIPDOGateway Binary:

The process of converting a backward IDL file to a ClientIPDOGateway is identical to the creation of the ClientIVDOGateway, but this time the IPDO is the distributed object client to the IVDO on the rare occasion when the IPDO need to invoke methods that implemented by the IVDO.

Implementables:

ProxificationIDLCompiler that inserts gateway code in the proxy modules.

Assign some computers in the computing utility as the gateway computers during the process of adding computers to the computing utility.

4.7 Modifications to the Computing Utility Infrastructure to Facilitate Proxification:

In order to achieve the objectives of trusted communication between the communicating peers on the two side of the boundary of trust, some other elements of the computing utility infrastructure needs to be enhanced. These enhancements are described in this subsection.

4.7.1 Distributed Object Middleware on Gateway Computers:

The distributed objects that are executed on the gateway computers right on the periphery of the boundary of trust have different security requirements than the ones that are executed within the inside of the computing utility.

Objects such as ClientIPDOGateway give access to the invocation of methods implemented by IVDO objects. In order to access distributed object servers, the distributed object technologies typically require the distributed object client to connect to a distributed object middleware element that the server object is connected to. The other possibility is that the distributed object middleware elements used by the client object and the server object are connected and can share common services such as naming. The following sub sections describe the requirements of distributed objects executing on gateway computers and the additional tasks that need to be performed by the distributed object middleware elements to facilitate the adherence of distributed objects on gateway computers to the security requirements.

4.7.1.1 The Requirements of Connectivity on Distributed Objects Executing on Gateway Computers:

1.0 The IPDO which is a client to the ClientIPDOGateway should be able to use the ClientIPDOGateway distributed object but it should not have direct access to other objects that are currently instantiated within the computing utility. In other words, IPDO on connecting to the distributed object middleware element on the gateway computer should not be able to bind to other objects that are instantiated within the computing utility directly.

2.0 The distributed objects that reside within the boundary of trust inside the computing utility should all be able to connect to distributed object servers executing on the gateway computers.

With the above two requirements to ensure that the access to resources inside a computing utility are controlled for their security concerns, the distributed object middleware needs to perform the following additional tasks.

1. The distributed objects executing on the gateway computers connect only with the distributed object middleware that is executing on gateway computers.

2. The distributed object middleware grants all the objects within the boundary of trust of the computing utility the capacity to bind to server objects that are executed on the gateway computers.

3. The distributed object middleware also permits the objects external to the computing utility, access to only those objects that are executing on the gateway computers.

4. The external clients can connect only to the distributed object middleware elements that are executing on the gateway computers. In effect the namespace visible to computing utility external objects is restricted by the distributed object middleware executing on the gateway computers.

5. The individual distributed objects may have additional authentication and authorization exchanges for additional security grant access to the distributed objects.

An example of additional security between the distributed objects across the computing utilities' boundary of trust:

For instance, an IPDO and an IVDO may by the semantics of their interface have an expectation of the IVDO invoking the authentication method of the IPDO. The application that uses the IVDO may use the users local authentication storage internet widget for accessing the password/username specific to the IPDO information that is stored on some secure storage such as a smart card. (The smart card like storage will enable secure SSO—single sign on as the user needs to remember only the password of the smart card in order to supply the password and username that may be different for different IPDOs.) This authentication exchange may supply a session credential that needs to be supplied by the IVDO to access the methods of the IPDO.

A plausible technique that would enhance traditional distributed object technology is by extending the classes that implement the distributed object middleware and make it part of the core internet widget network software set in such a way that the methods that are invoked to get a reference of a server object by the client object distinguish between the clients that are external to the computing utility and the clients that are internal to the computing utility.

4.8 The Invocation Sequence of the ClientIVDOGateway:

As we described earlier, the proxification of interfaces happens in the first invocation of a synchronized application that needs to connect to one or more IPDOs that are outside the boundary of trust of the computing utility to function properly. Besides the creation of the ClientIVDOGateway and the ClientIPDOGateway, these objects have to be instantiated and the connections and the couplings appropriately made.

By specification, the computing utility gateway computers do not execute any code other than the code that is designated as part of the trusted computing base. The ClientIVDOGateway and ClientIPDOGateway that are generated by a ProxificationIDLCompiler are designated to be part of the trusted computing base and hence can be instantiated on the gateway computers.

The IVDO on the initial execution of the synchronized application causes the creation of the ClientIVDOGateway binaries. The cached versions that are locally stored in some local file/data storage source of these ClientIVDOGateway binaries may be used in subsequent invocations.

Here is the sequence of invocation of the various ClientIVDOGateway objects:

1.0 The IVDO indicates to the gateway instantiation subsystem to invoke the ClientIVDOGateway binaries corresponding to the IVDO.

2.0 The ClientIVDOGateway binary in turn connects with the distributed object middleware element on the gateway computer of the computing utility in which the external IPDO is executing.

3.0 The IVDO is informed of the completion of the above two tasks.

4.0 The IVDO then connects to the ClientIVDOGateway as a client.

5.0 The ClientIPDOGateway connects with the IVDO as a client.

Implementables:

Distributed object middleware on gateway computers with the additional requirements of proxification.

4.9 Exporting a Service and Namespace to Distributed Objects Outside the Boundary of Trust in a Computing Utility:

One of the aspects of synchronized computing that makes it extremely elegant is our ability to build IPDOs within a computing utility and export access to the IPDO in a secure manner.

The proxification model used for monitoring access to the outside world by IVDOs is again used to ensure that the invoker of the IPDO creates a trusted policy instead of the developer of the IPDO. It is expected that the developer of the IPDO will be different from the deployer of an IPDO. For instance a software/internet widget vendor may develop the IPDO binaries for an IPDO that implements banking solutions, but a commercial bank may deploy the IPDO to provide the actual banking IPDO. In fact, the IPDO itself is made available by an internet widget provider as a synchronizable application that can be executed inside the boundary of trust of the computing utility used by the service provider.

The same forward IDL files and the backward IDL files that were used in the creation of ClientIVDOGateway objects are used in the creation the ServerIPDOGateways. The implementation details of proxification of an IPDO are not repeated, but it is sufficient to say that they perform identical tasks as their counter part ClientIPDOGateways do.

The proxification of the IPDO exports a service and its namespace to the outside world so that IVDOs used by applications to connect with the IPDOs can utilize these services.

Implementables:

Exporting of IPDO namespace.

6.0 Test Methodology of Testing Internet Widgets in Synchronized Computing:

In this section we briefly describe a test strategy that would work well for internet widgets. As internet widgets are expected to execute in disparate computing utilities with different configurations, it is essential that the advertised interfaces function true to the specification.

One technique for ensuring extensive testing of the internet widgets is make it possible creating test cases every time an internet widget is executed. This is at this stage a description of an idea that needs to be further developed for building the test infrastructure. However in the interim traditional test techniques will have to suffice.

The expectation is that during the execution of an application, a particular internet widget can be isolated for test creation for that specific internet widget. It involve the following modifications to facilitate test creation.

Trace the internet widget execution run:

In order to repeat the execution of an internet widget as it is used in a given application run, we need a way to drive the internet widget with the same sequence of method calls the way they get invoked in the execution of an application using the same arguments that are used in the execution. The proxification technique can be extended to create a proxy that traces the execution by inserting the trace of the sequence of method invocation and the serialized arguments used in the invocation. This trace log can then be used to drive the internet widget in isolation without the entire application that was originally used. Insert the trace code instead of gateway code for this purpose.

Simulate the return values:

Considering the internet widget in turn will execute additional internet widgets, in order to test the target internet widget in isolation it should be possible to generate the right return values even when the actual execution does not use the dependent internet widgets. This would in the test creation phase require capturing of the trace of the dependent internet widget execution. In other words, the map of the method, arguments is stored along with the corresponding return value for that execution. The proxification of the dependent internet widgets will make it possible for the creation of the execution run map. During the test run of the target internet widget, when the dependent internet widgets are operated on with the method, argument values the test execution framework uses the map created in the actual test creation run to return the saved return value instead of actually executing the method of the dependent internet widget.

The state of the target internet widget itself is captured at the beginning and the end of the execution during the test creation time and the test execution time to compare with the values captured during the test run with the golden copies.

The above method of test creation will immensely improve the number of test cases that can be generated by willing users of the internet widget, and improve the avoidance of regressions when internet code is changed and tested against a previously useful run of the internet widget.

The technique needs to be extended to account events and not be restricted to the method calls.

7.0 Various roles of people using synchronized computing:

With various types of software paradigms, we can identify various roles that are commonly performed by people providing solutions to the users of the software. Some of the familiar roles that were involved in traditional software development are software developers, systems administrators, software users etc. With synchronized computing too we have some roles that have distinguishing characteristics that will be defined in brief detail in order help the new comers better understand synchronized computing.

The roles are:

1. Internet widget developer

2. Internet widget service supplier

3. Internet widget IPDO service supplier

4. Internet widget IPDO service deployer

5. Internet widget Application service supplier

6. Internet widget Application service deployer

7. Application user

7.1 Internet Widget Developer:

An internet widget developer develops internet widget software that in itself may or may not be an application. Typically, the internet widget developer developed internet widgets are consumed by other internet widgets. A virtual service internet widget that is developed has two parts that may be executed in different computing utilities. An internet widget developer will have to make it possible for the people that want provide a software service by executing an instantiation of IPDO and also those that want to execute applications that use these IPDOs. An internet widget developer uses the internet widget service supplier to facilitate the usage of internet widgets in both forms.

7.2 Internet Widget Service Supplier:

Internet widget service supplier is the one that exports the internet widgets for them to be deployed. As internet widgets can be deployed as IPDOs and applications, the internet widget service supplier role has been sub-divided into the roles of an Internet widget IPDO service supplier and internet widget application service supplier.

7.3 Internet Widget IPDO Service Supplier:

Internet widget IPDO service supplier supplies the binaries that are necessary to deploy the IPDO at some location that is of interest to the IPDO deployer. An IPDO synchronization set is created to be externally visible that any user can point their application launcher to deploy the IPDO within her computing utility.

7.4 Internet Widget IPDO Service Deployer:

An internet widget IPDO service deployer is the one that instantiates an IPDO that provides some useful service functionality that can be shared by multiple applications. Typically an IPDO deployer also becomes an internet widget application service deployer as well as the IPDOs invariably tend to be bound to some application or another. The internet widget IPDO service supplier also helps the IPDO deployer to become an internet widget application service deployer if necessary by pointing to the internet widget application service suppliers that are known to the internet widget IPDO service supplier that use the IPDO that is being deployed.

7.5 Internet Widget Application Service Supplier:

An internet widget application service supplier is the special case supplier of internet widget service supplier. The internet widget application service supplier is the one that helps the application deployers to deploy the application by supplying the software necessary to deploy which in turn can be executed by the users of the application. In effect the internet widget application service supplier makes visible the synchronization set that can be pointed to invoke the deployment of the specific internet widget application.

7.6 Internet Widget Application Service Deployer:

Internet widget application service deployer is the one that actually deploys the application that end users use to benefit from the computation that is performed by the internet widgets. Internet widget deployer uses an internet widget application service supplier to deploy the application. On deployment a synchronization set that users can point to invoke the application is exposed on the internet widget application service deployment.

7.7 Internet Widget Application Service User:

The internet widget application service user is the one that invokes the application to perform some useful task. The internet widget application service user points the application launcher to the synchronization exported by an application service deployer to initiate the invocation of the internet widget application.

8.0 Scenarios of Usage of Synchronized Computing:

In this section we will describe a few scenarios of synchronized computing that will enunciate the advantages of computing using this model of computation. Subsequently we will enumerate various advantages in using this model of computation. The plausible ways in which applications can be developed using this model of computation that enables software users, software developers, software purchasers and software deployers to benefit over using other models of computation are too numerous to be enumerated in this document. Other documents will be developed for that explicit purpose to help software community to understand the ways in which they can benefit by using this model of computation.

8.1 A Book Store Application Scenario:

A book merchant would want customers to be able to purchase books from their computers. She has the following requirements.

The tasks of the book store merchant in enabling the customers:

Assumptions:

The customers have a computer that is connected to the internet. The book vendor has one or more computers that are connected to the internet.

1. Make it possible for a user to browse the books that can be sold by the vendor.

2. When the customer wants to purchase, the customer will transfer money from the financial institute that the user uses for banking needs to the book vendor.

The tasks of the book store software application developer (that uses synchronized computing):

1. Create a book vendor virtual service internet widget that has the following elements.

a. An IPDO object that operates on book vendors book data

b. An IVDO object that executes on the primary plane of execution of the customer's computing utility

c. A visualization object that corresponds to the IVDO object.

2. Search using “Qme” like technology for a banking virtual service internet widget IVDO interface definition and implementation.

3. Create a book purchasing application using the book vendor virtual service internet widget and the banking virtual service internet widget with the following application features.

a. The synchronization set that is pointed to by the customer will execute the book purchasing application on the customer computing utility.

b. The book purchasing application will bind with a locally used banking service (refer to the binding with a local service section) to bind with the bank that the customer uses for his banking needs.

4. The software developer may make it possible for the book vendor to deploy the IPDO on the book vendors computing utility using an internet widget IPDO service supplier.

5. The book purchasing application is supplied to the book vendor using an internet widget application service supplier used by the software developer.

6. The book purchasing application itself is made visible to customers by the book vendor, where the book vendor is the internet widget service deployer for the book purchasing application.

The actions of the customer:

1. Search using “Qme” like technology to find the various book vendors that may be selling the books to locate the book purchasing application launching synchronization set.

2. Point the application launcher to the book purchasing application of choice.

3. During the book purchasing application, identify the banking service that is to be used by the book purchasing application.

Some salient steps in the work flow of the application:

1. The synchronization set of the application is used by the user to launch the application

2. The root level internet widget of the application is synchronized to be executed on the computing utility of the user that invokes the application.

3. The book vendor internet widget is synchronized to be executed on the computing utility of the user that invokes the application.

4. The root level internet widget of the application synchronizes the IVDO of a banking service.

5. The invoked IVDO finds the bank that the user uses by searching the users name space and binds with a banking IPDO.

6. On purchases, the book service internet widget application extracts the requisite money from the user's bank and passes this to the book vendor IVDO. The transaction takes place without the user providing the bank information that is not needed by the book vendor to complete the transaction. In traditional computing the user would have to provide the vendor the information about the user's bank (such as credit card number) that allows the vendor to do more than the user is interested in allowing the vendor to do.

Advantages over traditional models of computing:

1 .The deployer of the IPDO need not plan for computational & storage capacity as the model of computing utility enables the deployers of the IPDO to dynamically acquire capacity without physically acquiring any hardware. All that the deployer does is to invoke a synchronization set that deploys the IPDO on the computing utility that the deployer is connected to. The computing utility provider can augment the capacity of the computing utility as and when the computing utility needs additional computing power.

2. The user of the application needs to provide only requisite and approved information to the external services, and hence has greater security in this model of computation.

3. The code that connects the various services involved in the execution of the application i.e the IVDOs actually is executed within the boundary of trust of the user.

4. Reuse of the pre-fabricate internet widget for banking service.

8.2 The Scenario of a Collaboration Application that Shares the 3D Models:

A corporation would like to use an application that will enable the engineers to share 3D models of engineering diagrams.

The corporation has the following requirements:

1. The 3D model sharing application should have the performance characteristics that require quick response time for the user interactions with the model.

2. The collaboration application should be complemented with other collaboration facilities such as a chat room, and video conferencing.

3. All the code that is executed should be executed on computers that the corporation trusts.

4. The 3D data and other collaboration data should not leave the computers that the corporation trusts.

The tasks of the corporation application purchaser and deployer in enabling the engineers:

1. Search for an internet widget service supplier that may be able to supply the software solution with the above specified requirements.

2. If there is no such internet widget service supplier, then commission a software team to implement the above solution using company internal engineering resources or external engineering resources.

3. Deploy the internet widget IPDO services and the internet widget application which together form the software solution to be used within the corporation as specified. The internet widget IPDO service suppliers and the internet widget application service supplier are used to deploy the solution.

The tasks of the collaboration application software developer that uses synchronized computing model:

1. Create a virtual service internet widget for implementing 3D model viewing application that has the following elements.

a. An IPDO object that operates on the master 3D data model that is to be shared by multiple users.

b. An IVDO object that keeps the last updated 3D data model that is executed within the computing utility of the user that is among the group of users sharing the 3D data model.

c. A visualization object corresponding to the IVDO object implementing the 3D data model that renders the frame buffer that is written into by the IVDO object.

2. Search for an internet widget service supplier that can supply the following elements of chat service virtual service internet widget.

a. An IPDO service supplier for a chat service internet widget.

b. An IVDO implementation of the chat service internet widget.

c. The corresponding visualization object for the chat IVDO.

3. Create an application that uses the two of the above mentioned virtual service internet widgets in such a way that the user sees the UI of both the internet widgets mentioned above.

4. Use an internet widget service supplier to help supply the application in the following manner.

a. Create an internet widget IPDO service supplier for the 3D modeling IPDO

b. Create an internet widget IPDO service supplier for the chat service IPDO

c. An internet widget application service supplier that supplies the collaboration application.

The actions of the engineers using the application:

2. If the user does not already know where to point their application launcher to connect to the collaboration solution, then they use Qme like search technology discover where to find the application that they need to use to share collaborate with other engineers.

3. If the user already knows where to point the application launcher they then do so to invoke the application using the synchronization set of the application.

Some salient steps in the work flow of the application:

1. On deploying the 3D model IPDO and the chat service IPDO the two IPDOs are instantiated inside the computing utility of the corporation and hence within the boundary of trust of the corporation.

2. A root synchronization set may be specifically created for the application that will bind to the particular 3D model or a generic synchronization set can allow the binding of the application to the specific 3D model collaboration of interest to the user invoking the application.

3. Any user that wants to participate in collaborative work involving the 3D model points their application launcher to the root synchronization set of the collaboration application.

4. The primary execution plane comprising the IVDOs for the 3D model keep a replica of the master 3D model maintained for synchronization by the IPDO.

Advantages over traditional models of computing:

1. Re-use of prefabricated applications such as the chat internet widget.

2. Dynamic allocation of computing power commensurate to the needs of the data being processed.

3. External application is executed within the boundary of trust hence providing additional security.

4. The data operated does not leave the boundary of trust, which is typically necessary in internet centric app service provider solutions.

9.0 Enumeration of Various Advantages by Using Synchronized Computation Model:

Synchronized computing delivers several advantages to various players that are typically involved in development, usage and deployment roles. This section enumerates the advantages to these various players separately.

9.1 Advantages to the Software Purchaser:

With traditional software that is delivered using media the convenient pricing model was pay once and use forever. While this model of software purchasing may be convenient for some purchasers of the software, other models of pricing if technically feasible will make it possible for marketers to provide multiple purchasing options to consumers. With the ubiquity of internet other pricing models have been implemented in application delivery to users. The popular internet centric computing that is exported by portals as application service providers makes it possible to create other pricing options to software marketers. However, the ASP model has the limitations of fragmented trust and user data, no well defined boundary of trust, potential for user personal data leaking outside the users computing resources without user intent etc. The synchronized computing model addresses these problems and still provides the following pricing models for software marketers.

1. A pay per use model is an option internet widget vendors can make available to the software buyer.

2. A subscription model is another option internet widget vendors will be able to make possible for software purchaser.

The above models of pricing are made possible to the software marketer by synchronized computing along with the other advantages of synchronized computing over the traditional models of stand alone and distributed computing. The same models of software commerce were technically plausible in earlier models of computing, but in usage these options caused user inconvenience. For instance terminating a software applications usage on non-payment would impose a penalty of re-installation and communication between the vendor and the user that was costing the user in time. With synchronized computing, resuming subscription or re-using the same application after a previous usage that was paid for is as simple as pointing the application launcher to the synchronization set of the application.

9.2 Advantages to the Software Deployer:

3. Hardware capacity planning is obviated

In traditional paradigms of computation, the deployers of software had to plan for hardware capacity that is needed for executing the software. Capacity planning involved planning for requisite storage capacity, computational speed to deliver the performance characteristics (usability of response time, speed of execution for various work loads etc.) needed for using the software applications effectively. In shrink wrapped computation, the host computer on which the software was executed had to have the necessary hardware capacity and the software deployers had to ensure that the hardware indeed had the necessary capacity. In the case of the distributed computing model such as internet without synchronized computing some one had to plan for the requisite performance characteristics for the client side software elements and the server side software elements. Typically, no amount of planning will make it possible for the same hardware to be adequate for the needs of the software for the life span of software as resources tend to be shared and the capacity that is dedicated for a software is not guaranteed for every instantiation of the software due to this reason. This is typically true for server side software that makes assumptions about the number of clients that tend to grow if the server functionality is desired. However scalable, the software written is if the hardware cannot be scalably augmented with the changing hardware capacity needs, the usability of applications degrade.

With the computing utility construct in synchronized computing, additional capacity or new hardware with better performance characteristics can be scheduled dynamically by the instantiation subsystem for the software that needs powerful computational capacity. If a particular instantiation schedules below capacity, all that one needs to do is re-instantiate the application with a manual request for improved capacity (load history log is stored for better scheduling of resources in future synchronization sets). In future a simple recycling of the software will ensure better scheduling with the core instantiation software detecting poor capacity scheduling that is detected by the instantiating subsystem with future enhancements. This will be further enhanced when we can dynamically recycle individual internet widgets within an execution life span.

In any event the software deployer does not need to acquire and commit hardware whose utilization will change dynamically based on the usage of the software over an extended period of time. In synchronized computing the user can schedule on more powerful hardware as and when the user needs improved performance in the early versions of synchronized computing that will subsequently be automated.

4. Clearly defined boundary of trust that permits mobility of shareable data and hence communication with peers outside the boundary of trust in a secure manner.

In synchronized computing, a well defined boundary of trust separates how data and applications move between the boundaries of trust of the computing utility used for computation. Corporations and individuals place different degrees of trust on the malicious and benevolent usage of the data inside and outside a boundary of trust. For instance a corporation may trust all the employees of the corporation to access and modify certain data, but may not want anyone that does not belong to the corporation. In order to ensure that such policies can be easily implemented in networks of computers that may be connected to the internet, corporations and individuals create boundaries of trust using technologies such as firewalls. Technologies such as firewalls prevent peers outside the boundary of trust from accessing resources inside the boundary of trust but for very limited access to select services that tightly controlled for limited access.

In undistributed software mode of computation and the distributed computing mode of computing that involves software executed inside the computers protected by firewalls, the boundary of trust can be defined by the resources protected by the firewalls. However if resources of distributed computing are outside the boundary of trust and in particular server resources then the boundary of trust would include the computing resources that power the server software due to the following rationale. In traditional client/server based distributed computing all the data necessary for computing has to be accessible to the server software to do useful computation, more than what is necessary in synchronized computing when the server objects reside outside the firewalls. For example a book selling service will require banking information to be saved with book selling service for the book selling service to be easily used in traditional distributed computing, and in synchronized computing the banking information of the user does not leave the boundary of trust as the book buying software executes the book purchasing application within the boundary of trust and the binding with banking service happens at run-time thus obviating the need to store the bank information with the book selling IPDO. In effect the user does not need to trust the book selling company to not abuse the banking information as would be the case in the distributed computing model. Thus if the user interacts with several external server objects, then the user and the corporation need to trust several organizations to not abuse the information. Thus the boundary of trust is less well defined in distributed computing model, unlike the synchronized computing model where all the information and data that does not have to be shared with an external service will be operated on using software that is executed on the computers inside the boundary of trust. This mode of computation makes the boundary of trust very well defined for the deployer, as the boundary of trust is defined by the resources used in the computing utility and the user and deployer do not trust the computers outside the boundary of trust with any information that need not be shared with an external service.

As there is no effective way for a corporation to ensure that the applications downloaded from outside sources do not pilfer data in other forms of computing, they tend to limit access of downloaded application to move data across a boundary of trust. This limiting of access is very rigid due to the fact that there is no effective way to protect pilferage of data while permitting the data that if shared will benefit the users. The policy tends to be defined for an entire corporation for all applications that are executed on the computers inside the firewalls. This is due to the fact that the infrastructure does not provide for a means to prevent and trace pilferage of data by malicious applications in a trusted manner. Synchronized computing with techniques such as proxification of interfaces makes it possible to monitor and prevent malicious pilferage of data in a trusted manner thus improving the types of applications that users can use that involve shareable data moving across the boundary of trust.

5. On demand increase of computational power.

In synchronized computing, the computing utility can expand the amount of computing power on demand as new computers can be dynamically added to a computing utility from the free pool. When the computing utility provider serves multiple computing utilities, then resource utilization is improved, price per computation decreased for the subscriber of a given computing utility. A more formal mathematical model is used to compute the cost per computation economics. With our invention, we can make it possible for people to use computing power the way electric power is used from the electric utilities.

9.3 Advantages to the Software Developer:

6. Software reuse

The internet widgets used in synchronized computing can be easily integrated to create more powerful applications. Compared to traditional computing components that increase re-use the internet widgets have the additional advantage that the components containing end-to-end software elements such as the server IPDO, IVDO and the visualization object for UI unlike other component technologies that componentize either the UI visualization software elements or the server elements but not both in an integrated manner.

7. Dynamic binding with available services within a computing utility

Synchronized computing makes it possible for applications downloaded to discover the locally available services that implement a specific interface and bind to them dynamically. This capability to bind with the locally available services by downloaded applications, makes it possible for disparate devices such as printers, scanners, smart cards easily integrated with the applications as the internet widgets that are already implemented can be re-used by the software developer. It is this capacity to bind dynamically with services that enables the integration of external services, while the code that integrates them is actually executed within the boundary of trust of the user.

8. Specialist creating the internet widget that comprises of all the layers from the UI to the hardware

In traditional distributed computing, the server objects are developed by one group of developers and the client UI objects are typically developed by several other developers, thus leading to duplication of effort and the development of software that is specific to the semantics encoded in the server/client objects that are peculiar for different types of services. In the case of internet widget based synchronized computing, the same experts can develop the IPDOs, IVDOs and the visualization objects corresponding to the IVDOs in the case virtual service internet widgets and in the case of the simple internet widgets the model IDOs belonging to the primary plane of execution and visualization IDOs belonging to the secondary plane of execution. This not only reduces the duplication of development effort, but makes it easier for using distributed objects for those that want to build applications using these services.

9. Makes it possible for developers to use virtual objects to program networked devices.

By virtue of the way virtual service internet widgets abstract the interface to networked devices, it makes it easy for application developers to use networked devices in their applications as the VSIW constituent components IDOs are object oriented. It also hides the tedium of multiple applications managing the access to the device in a meaningful way by requiring the IVDO and IPDO interaction handle that. That these networked devices have a framework where they can be dynamically discovered by applications, and that the application developers can use the IVDO and the visualization IDO to develop applications will make it possible for multiple applications to be built for various devices.

9.4 Advantages to the Hardware Developer:

10. A framework for creating networked devices that can be integrated into software applications with superior quality of integration

Any hardware device (such as disk storage, printers, scanners, clocks, washing machines, refrigerators, etc) that is constructed as a networked device can now be created with all the elements of software components necessary to programmatically operate the device including the visualization UI objects. This makes it possible for hardware designers to have tremendous control over the design and usage of the devices constructed by them, unlike traditional computing where the client UI software invariably is developed by some one other than the group (company) that constructs the hardware. The applications that use the client software can integrate the devices in their applications by programming with the interfaces exposed by the IVDOs, and utilize the UI functionality that is already implemented by the internet widget for the device.

11. Networked device operational framework.

The design of synchronized computing with internet widgets provides a framework for networked devices to dynamically become available so that other devices and applications can communicate with these devices. The framework makes it possible for devices to be dynamically discovered and bound to applications.

9.5 Advantages to the Software User:

12. Consolidation of trust (i.e no fragmentation of trust)

As explained in the advantage number 4 (“Clearly defined boundary of trust that permits mobility of shareable data with peers outside the boundary of trust in a secure manner”) the user does not need to trust several external entities (web sites) with the information that can be potentially abused by an external entity. With synchronized computing, the only information that is shared with external entities is only that information that needs to be shared to benefit the user. Thus all the manipulation of the data that belongs to the user and should not be shared with external entities will be operated on by executables executing on computers inside the boundary of trust. In effect, the user will need to only trust the computers within the boundary of trust to be not hostile. This in turn translates into the consolidation of trust to one entity that manages the computers that are added to the computing utility and not all the external entities that the user interacts with for useful computation.

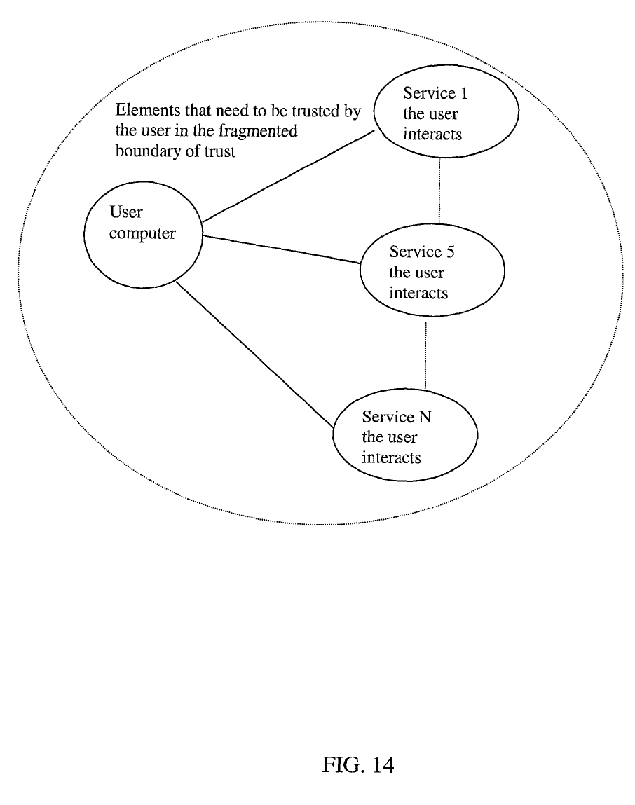

Pictorially shown in FIG. 14:

Distributed computing has the following trust model shown in FIG. 14.

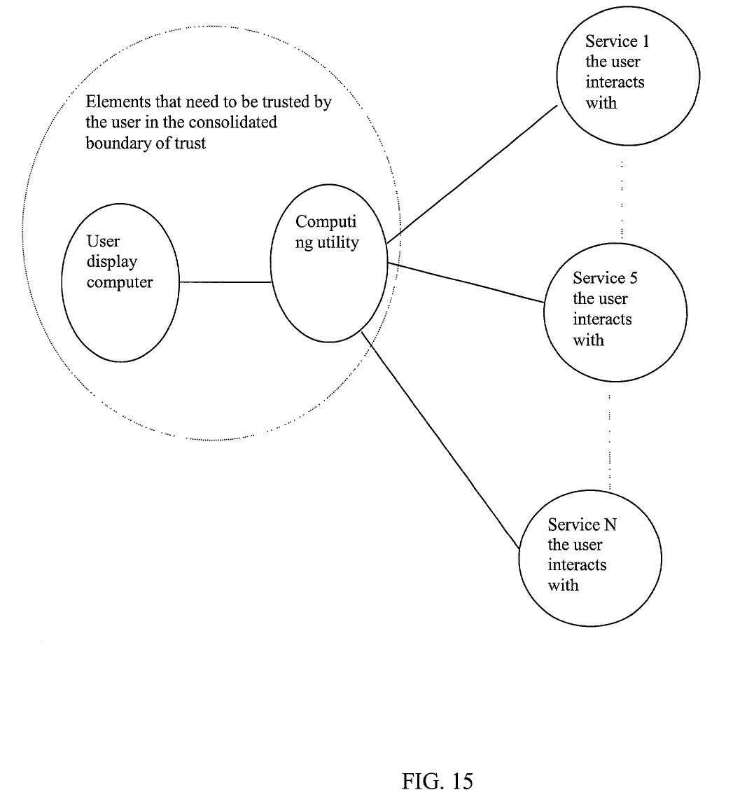

In synchronized computing as shown in FIG. 15,

13. Consolidation of user data (i.e no fragmentation of user data)

As with trust, the data also gets fragmented in the traditional distributed computing model, where several entities keep the user data for providing some useful service. If the user interacts with multiple entities then the number of places the data that belongs to the user is stored is large enough make it difficult for the user to manage her data. Some of the problems that come about in the model where the data is stored in external entities storage are:

1. It locks the user to the service to a degree where a superior service by another entity cannot be subscribed due the impedance placed by the current service provider in switching to a new service.

2. It makes it difficult to use applications that operate on data that is stored in multiple entities. For example, one may store their medical data with multiple health providers, the insurance data with another entity etc. In distributed computing model the various entities that the user interacts with need to be connected for me to use integrated applications that operated on medical and insurance data. In synchronized computing, even if the entities that the user interacts with are not connected, it is possible for the user to use applications that operated on data that is used by these two different entities.

Thus fragmenting data is not in the interest of the user that owns the data. In synchronized computing the model/primary plane execution object or the IVDO objects are serialized to storages that reside inside the boundary of trust and hence the data is stored in a consolidated way where all user data is accessible to all user applications. This consolidation of data makes it possible to create applications that operate on data that is created for use by multiple applications. Another example that illustrates this is when one subscribes to multiple banks, in synchronized computing it is possible to create financial applications that operate on all user data that is related to multiple banks even when the individual banks do not interact with each other electronically. In traditional distributed computing that is web centric this is not as simple.

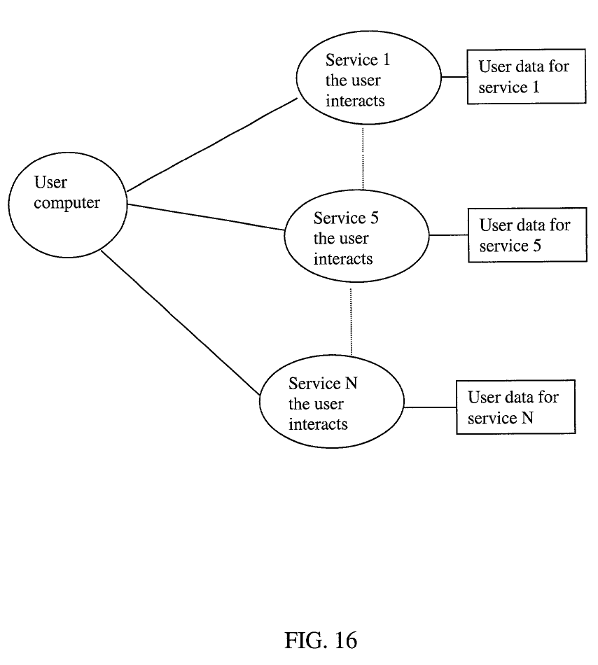

Pictorially, in distributed computing the user data fragmentation is shown in FIG. 16:

As you can see the user data is fragmented, thus making it difficult to create applications that operate on data that is resident on different service sites.

For instance to create an application that operates on the data that resides on site 1, and site 4 the application need to know the data formats used by the two sites that due to the lack of mandatory standardization in distributed computing make it extremely difficult to create integrated applications. Also, the sites 1 and 4 may not make it easy for storing a version of the user data kept on the server sites also on the user computer, or make it difficult for applications that are not created by sites 1 and 4 to use the data by not exporting the data to be manipulated programmatically.

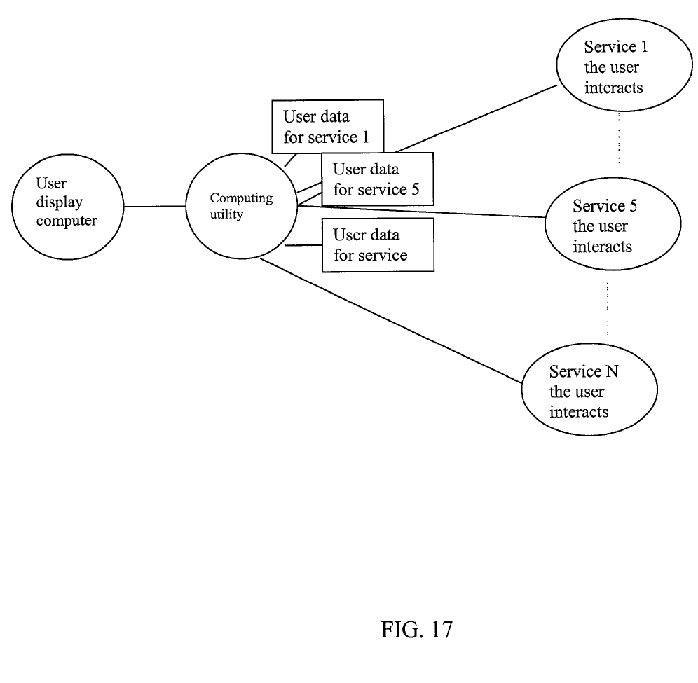

Pictorially, the consolidation of the user data is shown in the FIG. 17.

In this model all the user data pertaining to various services resides on resources that are inside the user computing utility, and these resources are accessible by all the applications launched by the user. The server sites have to make it possible for the user data to be programmatically manipulated in synchronized computing by creating the IvDOs of the server IPDOs, and the IVDOs that are serialized will store the data locally to manipulated by applications that are not necessarily developed by the individual sites.

14. Improved security for executing applications from dubious sources

Techniques such as proxification of interfaces make it possible to execute applications from various sources, some of them dubious, in a more secure way.

15. Infinitely scalable computing utility

The only limit on the user to acquire additional computing capacity to execute heavy work loads is the unavailability of additional computers in the free pool maintained by the computing utility provider. For a large user base, the computing utility provider can amortize the price of maintaining reasonable free buffer size in effect creating an infinite pool for the individual user. This is not a feature that is currently offered by any of the contemporary computing models.

16. Superior integration of hardware that is part of the user's home compute set

As we had mentioned in the advantage numbered 9—“Creating networked devices that can be integrated into software applications with superior quality of integration”, the devices such as smartcards, printers, storage devices, washing machines, kitchen ranges, dish washers, medical devices, factory machines etc are all more easily integrated into various applications due to the availability of internet widgets for these devices. Thus software applications that operate these devices can be easily executed inside the boundary of trust by obtaining them from external sources in synchronized computing. In fact multiple applications that work with devices and do other useful work (as would be the case with smart cards) can be more easily developed with the availability of virtual service internet widgets for these devices.

17. Secure single sign on with multiple internet services that have different usemames and passwords

As the internet widgets that interact with external services execute inside the boundary of trust of the computing utility and bind with the local services, storing different usernames and passwords in a secure local storage such as a smart card using the smart card virtual service internet widget will make it possible for the users to experience the benefits of secure single sign on, where they authenticate with the smart card using their pin and this will retrieve the passwords and usernames for the services that the user interacts with.

18. Ubiquitous access to computing, application and data resources

By design, all resources that the user needs for using software solutions are accessible from any location that the user chooses to connect her home compute set to her computing utility.

19. Easy migration between computing utility providers

As the user that uses a computing utility has their data consolidated, migrating from one computing utility to another computing utility is as simple as disconnecting the data service from one provider and connecting to the new computing utility provider. (this could mean copying the data or purchasing the storage on which the data is kept and handing over to the new utility provider. It is also conceivable that the data service may be purchased from a different vendor than the computing utility provider in which case switch computing utility provider is even easier.) Unlike other utilities such as electricity, telephone, cable TV the user can allow the market forces to reduce the price through competition and find the most economic supplier of computing power.

10.0 Software Pricing Strategies in Synchronized Computing:

With synchronized computing it will be possible to create pay per use and subscription models of computation by creating software applications with limited life span that can be extended by the core TCB instantiating component contacting the internet widget service supplier or the service deployer as specified by an argument in the synchronization set. Thus a paying customer will not be inconvenienced post subscription expiration, while the unpaying will not be able to use the previously downloaded internet widgets after the duration for which the user has paid.

11.0 Conclusions:

In this document we have described the technological elements that together form the core of synchronized computing. Besides presenting with sufficient detail the specification of the technological elements to help the implementation of the core technology for synchronized computing, we also enumerate several benefits of using synchronized computing. The reader is referred to “The economics of synchronized computing in comparison with traditional computing, by Shankar Narayan” for additional analysis of synchronized computing, which is herein incorporated by reference in its entirety.

### Hardware Overview

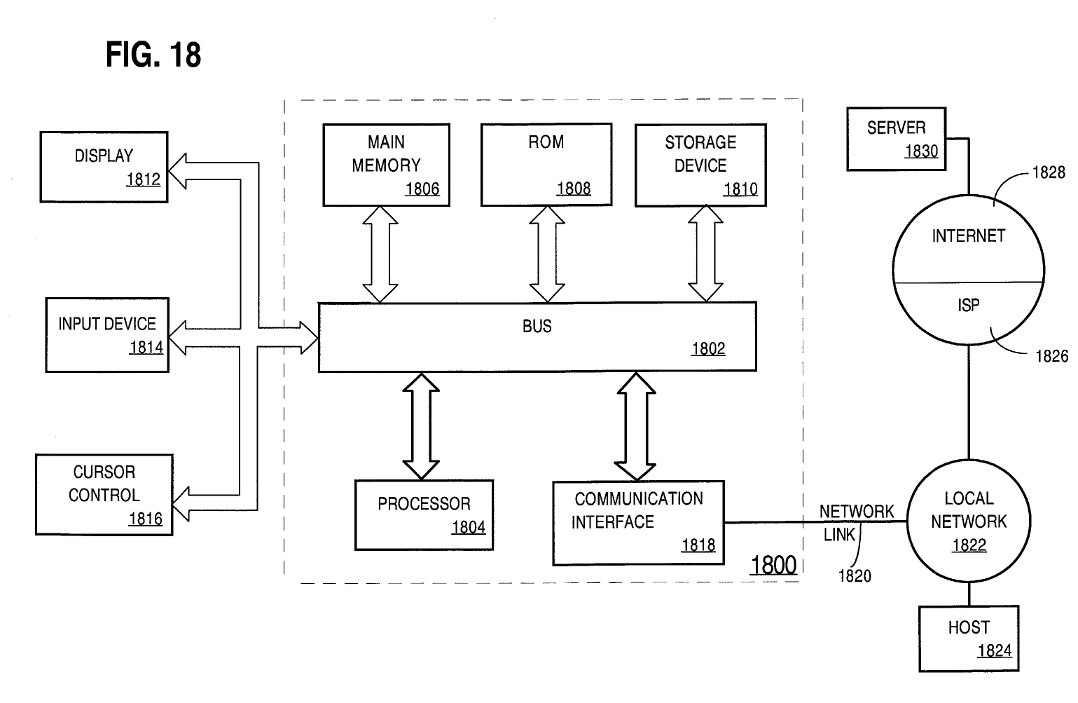

FIG. 18 is a block diagram that illustrates a computer system 1800 upon which an embodiment of the invention may be implemented. Computer system 1800 includes a bus 1802 or other communication mechanism for communicating information, and a processor 1804 coupled with bus 1802 for processing information. Computer system 1800 also includes a main memory 1806, such as a random access memory (RAM) or other dynamic storage device, coupled to bus 1802 for storing information and instructions to be executed by processor 1804. Main memory 1806 also may be used for storing temporary variables or other intermediate information during execution of instructions to be executed by processor 1804. Computer system 1800 further includes a read only memory (ROM) 1808 or other static storage device coupled to bus 1802 for storing static information and instructions for processor 1804. A storage device 1810, such as a magnetic disk or optical disk, is provided and coupled to bus 1802 for storing information and instructions.

Computer system 1800 may be coupled via bus 1802 to a display 1812, such as a cathode ray tube (CRT), for displaying information to a computer user. An input device 1814, including alphanumeric and other keys, is coupled to bus 1802 for communicating information and command selections to processor 1804. Another type of user input device is cursor control 1816, such as a mouse, a trackball, or cursor direction keys for communicating direction information and command selections to processor 1804 and for controlling cursor movement on display 1812. This input device typically has two degrees of freedom in two axes, a first axis (e.g., x) and a second axis (e.g., y), that allows the device to specify positions in a plane.

The invention is related to the use of computer system 1800 for implementing the techniques described herein. According to one embodiment of the invention, those techniques are performed by computer system 1800 in response to processor 1804 executing one or more sequences of one or more instructions contained in main memory 1806. Such instructions may be read into main memory 1806 from another computer-readable medium, such as storage device 1810. Execution of the sequences of instructions contained in main memory 1806 causes processor 1804 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 1804 for execution. Such a medium may take many forms, including but not limited to, non-volatile media, volatile media, and transmission media. Non-volatile media includes, for example, optical or magnetic disks, such as storage device 1810. Volatile media includes dynamic memory, such as main memory 1806. Transmission media includes coaxial cables, copper wire and fiber optics, including the wires that comprise bus 1802. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of computer readable media may be involved in carrying one or more sequences of one or more instructions to processor 1804 for execution. For example, the instructions may initially be carried on a magnetic disk of a remote computer. The remote computer can load the instructions into its dynamic memory and send the instructions over a telephone line using a modem. A modem local to computer system 1800 can receive the data on the telephone line and use an infra-red transmitter to convert the data to an infra-red signal. An infra-red detector can receive the data carried in the infra-red signal and appropriate circuitry can place the data on bus 1802. Bus 1802 carries the data to main memory 1806, from which processor 1804 retrieves and executes the instructions. The instructions received by main memory 1806 may optionally be stored on storage device 1810 either before or after execution by processor 1804.

Computer system 1800 also includes a communication interface 1818 coupled to bus 1802. Communication interface 1818 provides a two-way data communication coupling to a network link 1820 that is connected to a local network 1822. For example, communication interface 1818 may be an integrated services digital network (ISDN) card or a modem to provide a data communication connection to a corresponding type of telephone line. As another example, communication interface 1818 may be a local area network (LAN) card to provide a data communication connection to a compatible LAN. Wireless links may also be implemented. In any such implementation, communication interface 1818 sends and receives electrical, electromagnetic or optical signals that carry digital data streams representing various types of information.

Network link 1820 typically provides data communication through one or more networks to other data devices. For example, network link 1820 may provide a connection through local network 1822 to a host computer 1824 or to data equipment operated by an Internet Service Provider (ISP) 1826. ISP 1826 in turn provides data communication services through the world wide packet data communication network now commonly referred to as the “Internet” 1828. Local network 1822 and Internet 1828 both use electrical, electromagnetic or optical signals that carry digital data streams. The signals through the various networks and the signals on network link 1820 and through communication interface 1818, which carry the digital data to and from computer system 1800, are exemplary forms of carrier waves transporting the information.

Computer system 1800 can send messages and receive data, including program code, through the network(s), network link 1820 and communication interface 1818. In the Internet example, a server 1830 might transmit a requested code for an application program through Internet 1828, ISP 1826, local network 1822 and communication interface 1818.

The received code may be executed by processor 1804 as it is received, and/or stored in storage device 1810, or other non-volatile storage for later execution. In this manner, computer system 1800 may obtain application code in the form of a carrier wave.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

### REFERENCES

[DAVJ95] David Ferraiolo, Janet Cugini, and Richard Kuhn, “Role-Based Access Control (RBAC): Features and Motivations”, in Proceedings of 11^{th} Annual Computer Security Application Conference, pages 242-48, New Orleans, La., Dec. 11-15, 1995.

<URL:http://hissa.ncsl.nist.gov/rbac/newpaper/rbac.html>

[OMG97] Object Management Group, “The Common Object Request Broker: Architecture and Specification Version 2.1”, August 1997,

<URL ftp://ftp.omg.org/pub/docs/formal/98-12-01.pdf>

[SHAN00] Shankar Narayan, “An Architecture to Easily Create Integrated Service Ecosystems using Internet Widgets”, Sep. 19, 2000

[SUNM97] Sun Microsystems, “Secure Computing With JAVA™: Now And The Future”,

In JavaOnes™ Conference,1997.

<URL: http://java.sun.com/marketing/collateral/security.html>

[TIMF97] Tim Lindholm, Frank Yellin, “The Javam Virtual Machine Specification”, Second Edition, Copyright 1997-1999

<URL:http://java.sun.com/docs/books/vmspec/index.html>

[WYET95] W. Yeong, T. Howes, S. Kille, “Lightweight Directory Access Protocol”, RFC 1777, Isode Consortium, March 1995

<URL: http://www.ietf.org/rfc/rfc1777.txt>

[YOU] Young-Seock Cha,” E-Commerce Security Technologies Fire Wall,

<URL: http://secinf net/info/fw/ecom/>

What is claimed is:

1. A method for managing communication between distributed objects, comprising the steps of:
a client downloading an interface description that conforms to an interface description language, wherein said interface description describes a first set of methods that may be invoked by a first object to invoke a second set of methods of a second object, wherein said second object may be accessed by said client through a network;
said client examining said interface description and access policy data to generate one or more executable proxy objects that implement said first set of methods and that allow said client to call a particular method of said first set of methods in order to invoke a corresponding method of said second set of methods;
wherein said access policy data defines parameters that govern access between said client and other objects that may be accessed by said client over said network;
said client instantiating said first object on said client; and
said one or more executable objects governing access between said first object and said second object based on said access policy data.

2. A method for managing communication between distributed objects, comprising the steps of:
a client downloading an interface description that conforms to an interface description language, wherein said interface description describes a first set of methods that may be invoked by a first object to invoke a second set of methods of a second object, wherein said first object may be accessed by said client through said network;
said client examining said interface description and access policy data to generate one or more executable proxy objects that implement said first set of methods and that allow said first object to call a particular method of said first set of methods in order to invoke a corresponding method of said second set of methods;
wherein said access policy data defines parameters that govern access between said client and other objects that may be accessed by said client over a network;
said client instantiating said second object on said first client; and
said one or more executable objects governing access between said first object and said second object based on said access policy data.

3. A computer-readable medium carrying one or more sequences of instructions for managing communication between distributed objects, wherein execution of the one or more sequences of instructions by one or more processors causes the one or more processors to perform the steps of:
a client downloading an interface description that conforms to an interface description language, wherein said interface description describes a first set of methods that may be invoked by a first object to invoke a second set of methods of a second object, wherein said second object may be accessed by said client through a network;
said client examining said interface description and access policy data to generate one or more executable proxy objects that implement said first set of methods and that allow said client to call a particular method of said first set of methods in order to invoke a corresponding method of said second set of methods;
wherein said access policy data defines parameters that govern access between said client and other objects that may be accessed by said client over said network;
said client instantiating said first object on said client; and
said one or more executable objects governing access between said first object and said second object based on said access policy data.

4. A computer-readable medium carrying one or more sequences of instructions for managing communication between distributed objects, wherein execution of the one or more sequences of instructions by one or more processors causes the one or more processors to perform the steps of:
a client downloading an interface description that conforms to an interface description language, wherein said interface description describes a first set of methods that may be invoked by a first object to invoke a second set of methods of a second object, wherein said first object may be accessed by said client through said network;
said client examining said interface description and access policy data to generate one or more executable proxy objects that implement said first set of methods and that allow said first object to call a particular method of said first set of methods in order to invoke a corresponding method of said second set of methods;
wherein said access policy data defines parameters that govern access between said client and other objects that may be accessed by said client over a network;
said client instantiating said second object on said first client; and
said one or more executable objects governing access between said first object and said second object based on said access policy data.
